(19) United States
(12) Patent Application Publication
(10) Pub. No.: US 2025/0153555 A1
(43) Pub. Date: May 15, 2025

(54) IMPACT-PROTECTION DEVICES, SYSTEMS, AND ASSEMBLIES, AND METHODS OF MANUFACTURING, INTEGRATING, AND USING THE SAME

(71) Applicant: Daimler Truck North America LLC, Portland, OR (US)

(72) Inventors: Alexander Magnus LITTLE, Portland, OR (US); Rajashekar KALARASAIAH, Bangalore (IN); Sushmitha Mallappa SOMASHEKAR, Kuvempu nagar Mysuru (IN)

(21) Appl. No.: 18/941,658

(22) Filed: Nov. 8, 2024

Related U.S. Application Data
(60) Provisional application No. 63/597,623, filed on Nov. 9, 2023.

(51) Int. Cl. B60K 1/04; B60L 50/60; B62D 21/15; H01M 50/242; H01M 50/249; H01M 50/262

(52) U.S. Cl. CPC B60K 1/04; B60L 50/66; B62D 21/157; H01M 50/242; H01M 50/249; H01M 50/262; B60K 2001/0438; H01M 2220/20

(57) ABSTRACT

Impact-protection systems, devices, and components, as well as methods of manufacturing, integrating, and using the same, e.g., in connection with different vehicles including electric vehicles. The impact-protection systems described herein can be configured to be attached on the lateral sides of a vehicle and/or under or at least partially under a chassis frame of a vehicle to cover, enclose, and/or protect vehicle structures mounted in these areas. The impact-protection systems can include multiple configurations, e.g., being formed using brackets, panels, compartmented structures, fairings, and/or layers of different materials. The components of the impact-protection systems can be produced, assembled, and installed using efficient and cost-effective manufacturing and assembly methods. The impact-protection configurations described herein help reduce the concentration of impact-forces.

### CROSS-REFERENCE TO RELATED APPLICATIONS

This non-provisional patent application claims priority to co-pending U.S. provisional patent app. No. 63/597,623, filed Nov. 9, 2023, titled “Impact-Protection Devices, Systems, and Assemblies, and Methods of Manufacturing, Integrating, and Using the Same,” the entire contents of which is incorporated herein by reference in the entirety.

### TECHNICAL FIELD

The field relates to impact-protection devices for vehicles.

### BACKGROUND

Vehicles operating on roadways have the potential to encounter impact forces, e.g., from other vehicles, objects, structures, and the like. As a result, vehicles typically include impact protection features such as bumpers, shrouds, reinforcing structures, and the like. These features can help dissipate, distribute, and/or re-direct forces encountered during an impact scenario. Larger vehicles, e.g., including freight trucks, typically have larger profiles and larger clearances. These larger clearances can sometimes result in the vehicle's components, e.g., powertrain, fuel tanks, batteries, and the like, being supported under the chassis of the vehicle. This can expose the components to impact forces, e.g., side-impact forces in particular, especially when the supported components occupy a substantial amount of space and thus leave limited room for lateral impact-protection features.

### SUMMARY

This summary is intended to introduce a selection of concepts in a simplified form that are further described below in the detailed description section of this disclosure. This summary is not intended to identify key or essential features of the claimed subject matter, nor is it intended to be used as an aid in isolation to determine the scope of the claimed subject matter.

In brief, and at a high level, this disclosure describes, among other things, impact-protection devices, systems, and assemblies, and methods of manufacturing, integrating, and using the same, e.g., in connection with vehicles. The impact-protection devices, systems, and assemblies described herein can be integrated into combustion-powered vehicles, into electric-powered vehicles, and/or into hybrid combustion-electric powered vehicles among other types of mobile platforms, and can help limit exposure to impact forces and in addition can help absorb, dissipate, distribute, and/or redirect forces encountered during an impact scenario. This, in turn, can help reduce or limit the degradation of components in such instances. The embodiments described herein can also be manufactured, assembled, and/or installed with limited cost, complexity, and time, and can be implemented in configurations where limited space is available for lateral impact-protection features, among other benefits.

In embodiments, an impact-protection system is provided. The impact-protection system can include a pair of side-impact protection devices. The side-impact protection devices can be configured to be attached along opposite sides of a vehicle, e.g., adjacent to the chassis thereof. The side-impact protection devices each provide an impact-absorbing structure that is configured to at least partially enclose and protect components supported under the chassis. The impact-absorbing structure is configured to collapse, deform, and/or compress, at least partially, when subjected to impact forces, thereby allowing it to protect adjacent components. In embodiments, side-impact protection devices can be configured to enclose and protect powertrain-related components, electrical-related components, fluid-related components, fuel and/or gas tanks, pumps, motors, blowers, and/or other components or sub-systems that are supported at least partially on, under, and/or adjacent to the chassis of a vehicle. In embodiments, the side-impact protection devices can be configured to enclose and protect a battery system supported under a chassis of an electric-powered vehicle (e.g., a high-voltage battery system that supplies at least 400 volts). In embodiments, the side-impact protection devices can be configured to support or house additional vehicle components and/or features, e.g., fairings, steps, brackets, cables, wires, conduits, pipes, hoses, circuits, and the like, in addition to providing impact protection. The side-impact protection devices can be incorporated in locations where there is limited available space, and can also be manufactured and installed using simpler, more efficient, and more cost-effective manufacturing and assembly methods which, in turn, can help improve manufacturing efficiency and sustainability, among other things.

In embodiments, a side-impact protection device is provided. The side-impact protection device can include one of multiple configurations that provide an impact-absorbing structure that can collapse, deform, and/or compress, at least partially, when subjected to impact forces. In embodiments, the side-impact protection device can include one or more brackets, one or more panels, one or more compartmented structures, and/or one or more distinct materials, layers of material(s), and/or combinations of material(s) that are suitable to absorb, dissipate, distribute, and/or redirect impact forces. These elements can be selected and configured so that a side-impact protection device can fit into a lateral space adjacent to a supported structure, while also protecting the structure from a desired amount of impact forces. In embodiments, a side-impact protection device can be formed from a single unified piece, or can be formed from multiple pieces that are manufactured, assembled, and then attached together. The use of multiple distinct pieces to form a side-impact protection device can help enhance the efficiency of manufacturing, transport, and assembly.

In embodiments, a method of manufacturing an impact-protection system, e.g., that includes one or more side-impact protection devices, is provided. The method can include producing/forming one or more pieces of a side-impact protection device, e.g., from metal, metal alloy, composite materials, polymeric materials, or from a combination thereof. In embodiments, the pieces can be formed by molding, casting, extrusion, stamping, bending, cutting, boring, and/or through other additive or subtractive manufacturing or machining methods and techniques. The method can include assembling the pieces, and then attaching the pieces together to form the assembled side-impact protection device. In embodiments, the pieces can be connected using integrated attachment structures, and/or using fasteners (e.g., bolts, screws, rivets, pins, and the like), and/or through use of welding, bonding, adhering, or other attachment methods and techniques. In embodiments, the pieces of a side-impact protection device can be formed to allow for assembly with limited tooling. For example, the pieces can be formed (e.g., through extrusion, stamping, and the like) to include integrally formed connection structures, e.g., that provide male-female, interlocking, snap-in, friction fit, or interference fit connections, or other connections of a similar nature, that allow the pieces to be easily attached together.

In embodiments, a method of integrating an impact-protection system, e.g., that includes one or more side-impact protection devices, into a vehicle or other mobile platform is provided. The method can include positioning a pair of side-impact protection devices against opposite lateral sides of a structure, e.g., a battery system, that is supported at least partially on, under, and/or adjacent to the chassis of the vehicle. The method can include attaching, securing, or affixing each side-impact protection device to at least the lateral side of the component, e.g., directly or through one or more interposed structures. In embodiments, the attachment can be to the lateral side of the component and not to the chassis, e.g., to simplify the connection configuration especially when the component occupies a significant amount of space under/around the chassis. The method can include attaching a fairing, e.g., an aerodynamic fairing or panel, at least partially on, against, and/or around the side-impact protection device. In further embodiments, methods of operating, e.g., driving, directing, or routing/coordinating, one or a plurality of vehicles that include impact-protection systems and devices as described herein are provided.

### BRIEF DESCRIPTION OF THE DRAWINGS

The impact-protection devices, systems, and assemblies, and methods of manufacturing, integrating, and using the same described herein are discussed in detail in connection with the attached figures, which illustrate non-limiting examples of the disclosed subject matter, wherein:

FIG. 1 depicts a vehicle with a side-impact protection system, in accordance with embodiments of the present disclosure;

FIG. 2 depicts the vehicle of FIG. 1 with the side-impact protection system in exploded form, in accordance with embodiments of the present disclosure;

FIGS. 3A-3G are cross-sectional depictions of side-impact protection devices having different configurations, in accordance with embodiments of the present disclosure;

FIGS. 4A-4C depict different attachment structures, some integrally formed, that can be used to attach pieces of an impact-protection device together, in accordance with embodiments of the present disclosure;

FIGS. 5A-5D depict different types of panels that can form part of an impact-protection device, in accordance with embodiments of the present disclosure;

FIGS. 6A and 6B depict different perspectives of a side-impact protection device that includes a fairing, in accordance with embodiments of the present disclosure;

FIG. 6C depicts a cross-sectional perspective view of the side-impact protection device shown in FIGS. 6A and 6B, in accordance with embodiments of the present disclosure;

FIGS. 7A and 7B depict an impact-protection system for a vehicle in isolation, and from different perspectives, in accordance with embodiments of the present disclosure;

FIG. 8 is a cross-sectional perspective view of a side-impact protection device that forms part of the system shown in FIGS. 7A and 7B, in accordance with embodiments of the present disclosure;

FIG. 9 is a cross-section of a side-impact protection device, in accordance with embodiments of the present disclosure;

FIG. 10 is a cross-section of another side-impact protection device, in accordance with embodiments of the present disclosure;

FIG. 11 is a cross-section of another side-impact protection device, in accordance with embodiments of the present disclosure;

FIG. 12 is a cross-section of another side-impact protection device, in accordance with embodiments of the present disclosure;

FIG. 13 is a cross-section of another side-impact protection device, in accordance with embodiments of the present disclosure;

FIG. 14 is a cross-section of another side-impact protection device, in accordance with embodiments of the present disclosure;

FIG. 15 is a cross-sectional perspective view of another side-impact protection device that includes a honeycomb structure, in accordance with embodiments of the present disclosure;

FIG. 16 is a block diagram of a method of manufacturing a side-impact protection device for a vehicle, e.g., an electric vehicle, in accordance with embodiments of the present disclosure;

FIG. 17 is a block diagram of a method of integrating a side-impact protection device into a vehicle, e.g., an electric vehicle, in accordance with embodiments of the present disclosure;

FIG. 18 depicts another configuration of a side-impact protection system that includes a pair of side-impact protection devices, in accordance with embodiments of the present disclosure;

FIG. 19 depicts a cross-section of one of the side-impact protection devices of FIG. 18, in accordance with embodiments of the present disclosure; and

FIG. 20 depicts a perspective view showing part one of the side-impact protection devices of FIG. 18, in accordance with embodiments of the present disclosure.

### DETAILED DESCRIPTION

This detailed description is provided in order to meet statutory requirements. However, this description is not intended to limit the scope of the invention described herein. Rather, the claimed subject matter may be embodied in different ways, e.g., to include different steps, different combinations of steps, different elements, and/or different combinations of elements, similar to those described herein, and in conjunction with other present or future technologies and/or solutions. In addition, although the terms “step” and “block” may be used herein to identify different elements of methods employed, the terms should not be interpreted as implying any particular order among or between different elements except when the order is explicitly stated.

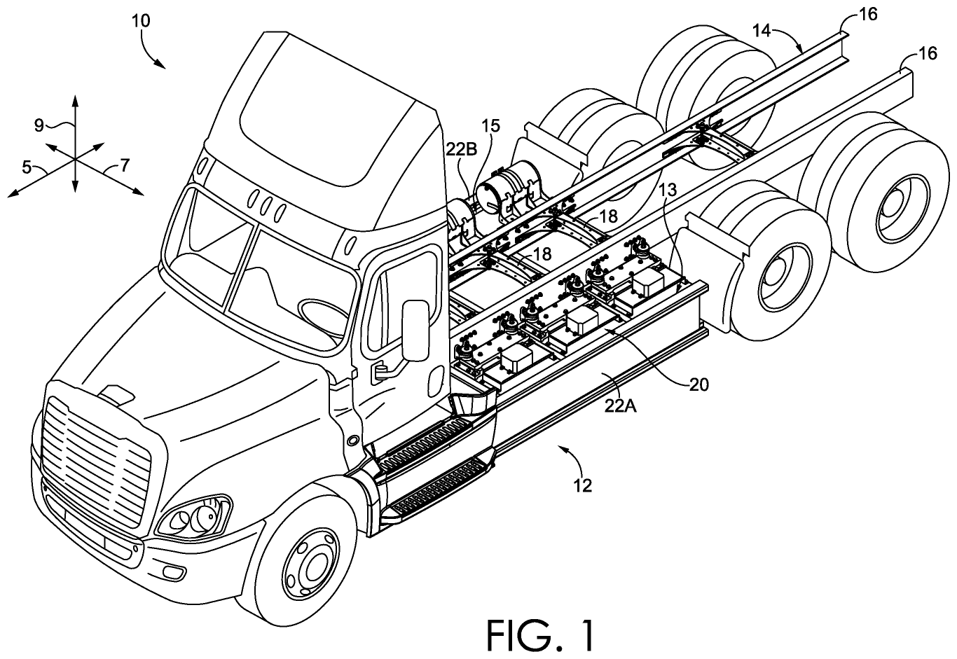

In general, and at a high-level, this disclosure describes, among other things, impact-protection devices, components, and assemblies as well as methods of manufacturing, integrating, and using the same, e.g., in connection with vehicles and other mobile platforms. The impact-protection configurations disclosed herein can help reduce exposure of certain components to impact forces, and/or help absorb, dissipate, distribute, and/or redirect impact forces encountered during an impact scenario thus helping to reduce the degradation of the components being protected in such instances. The impact-protection configurations disclosed herein can also be produced and installed with reduced cost, complexity, and time required for manufacturing and installation, thereby increasing the efficiency, throughput, and sustainability of manufacturing such components, among other benefits. Example embodiments that realize these benefits are described below in connection with attached FIGS. 1-20.

Looking now at FIG. 1, a vehicle 10 is shown, in accordance with embodiments of the present disclosure. The vehicle 10 includes a longitudinal axis 5, a transverse axis 7, and a vertical axis 9 as identified in FIG. 1. The vehicle 10 also includes a side-impact protection system 12. The side-impact protection system 12 includes a pair of side-impact protection devices 22A, 22B that are mounted on opposite lateral sides of the vehicle 10 adjacent to a chassis 14 thereof. In the embodiment of FIG. 1, the vehicle 10 is a freight tractor, e.g., one that can be attached to, and pull, a freight trailer. In addition, in the embodiment of FIG. 1, the vehicle 10 is an electric vehicle, e.g., is powered using an electric powertrain, e.g., one that operates using electric motors and battery-electric power. To power the electric powertrain, the vehicle 10 includes a battery system 20 that is supported by, and at least partially under, the chassis 14. The chassis 14 include a pair of elongated and substantially parallel frame rails 16 that are connected by transverse frame rails 18. The battery system 20 is supported by the chassis 14, or in other words, the battery system 20 hangs or is at least partially suspended under the chassis 14. To enclose and protect the lateral sides 13, 15 of the battery system 20, e.g., from potential impact forces, the side-impact protection devices 22A, 22B are installed onto, along, and/or against the opposite lateral sides 13, 15 of the battery system 20. The side-impact protection devices 22A, 22B are each configured to help absorb, dissipate, distribute, and/or redirect impact forces, and in particular those oriented at least partially in the transverse direction (e.g., axis 7 as identified in FIG. 1).

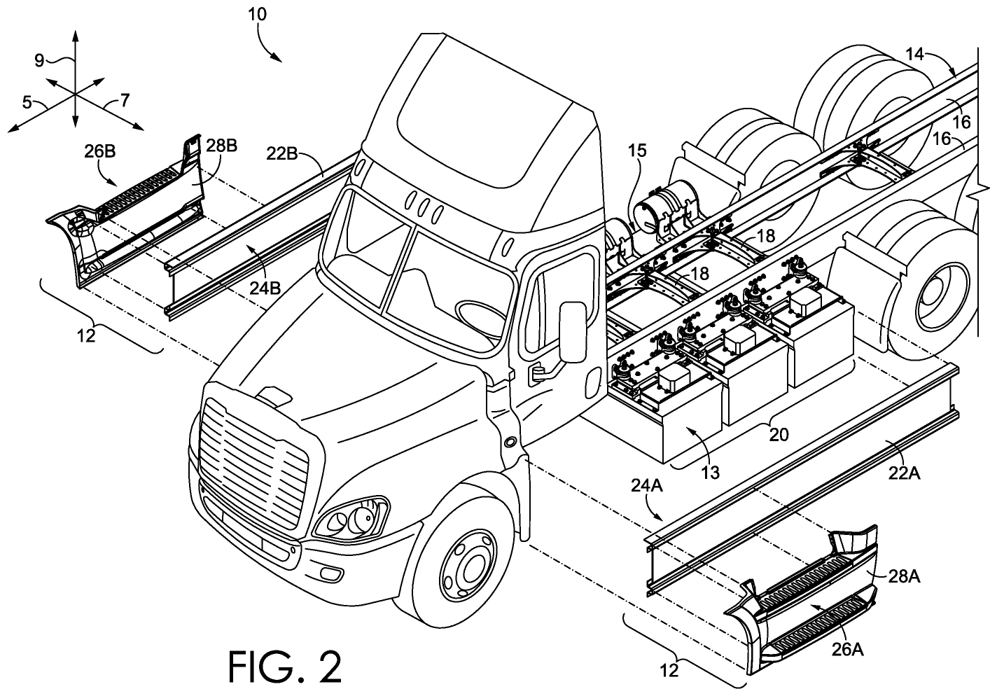

FIG. 2 shows the side-impact protection devices 22A, 22B generally in exploded form for clarity and explanation purposes, in accordance with embodiments of the present disclosure. It can be seen in FIG. 2 that each side-impact protection device 22A, 22B includes an inner-facing side, structure, or part 24A, 24B that attaches to at least a lateral side 13, 15 of the battery system 20, and an outer-facing side, structure, or part 26A, 26B that attaches to, integrates with, and/or supports, a corresponding fairing 28A, 28B. In accordance with embodiments described herein, each side-impact protection device 22A, 22B can be formed from a single unified component, piece, or structure, or can be formed from multiple distinct components, pieces, and/or structures that are formed, assembled, and attached together (generally as shown with configuration depicted in FIG. 2). In should be noted that any of the designs disclosed herein can be incorporated in place of the system 12 shown in FIGS. 1 and 2, which is depicted only for explanation purposes.

Looking still at FIG. 2, the battery system 20 is of significant size and occupies a significant amount of space under the chassis 14 in order to be capable of supplying the desired electrical capacity for the associated electric powertrain. This, as a result, limits the available space for side-protection protection features. However, the side-impact protection devices 22A, 22B shown in FIG. 2 and described herein are designed to be attached and secured against at least the lateral sides 13, 15 of the battery system 20, and/or to the chassis 14, to thereby limit the space required to incorporate the side-impact protection devices 22A, 22B into the vehicle 10. In addition, FIG. 2 shows how the side-impact protection devices 22A, 22B are each configured to support or have incorporated thereon fairing 28A, 28B. The integration of the fairings 28A, 28B allows the components to be integrated into a more compact, consolidated configuration that is suitable for the limited lateral space adjacent to the battery system 20.

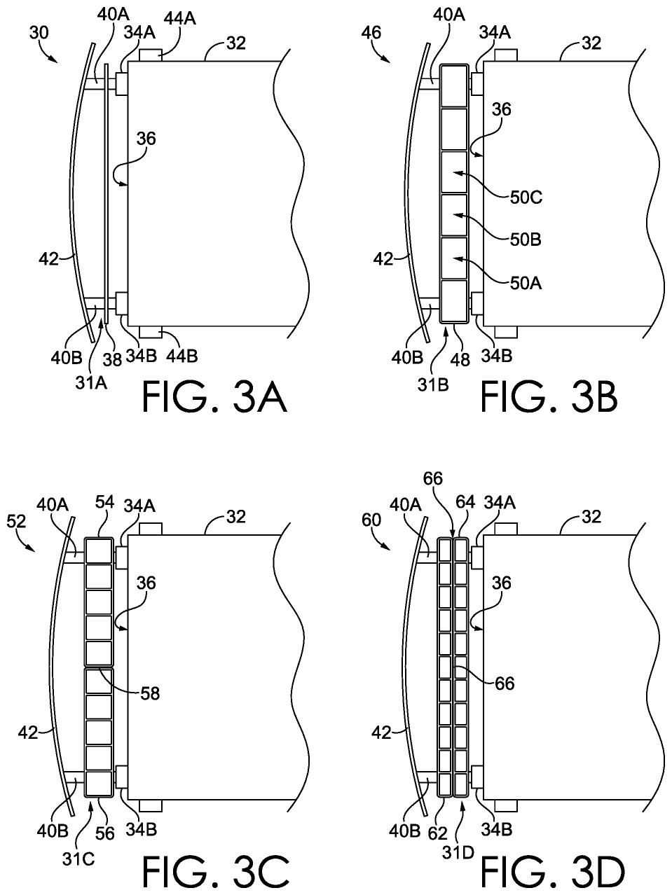

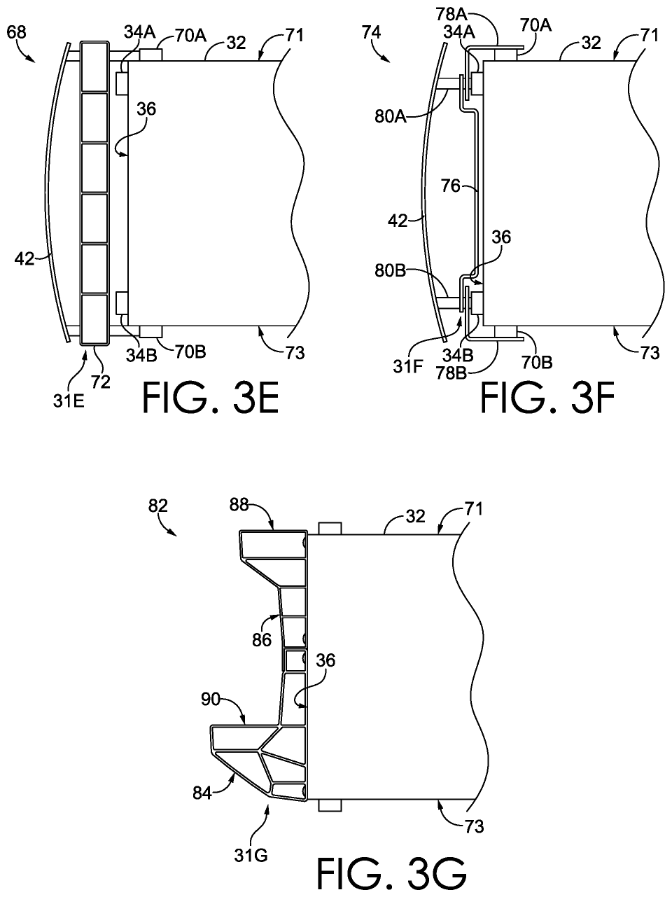

Looking now at FIGS. 3A-3G, a series of cross-sections showing side-impact protection devices having different configurations are provided, in accordance with embodiments of the present disclosure. The side-impact protection devices 30, 46, 52, 60, 68, 74, 82 shown in FIGS. 3A-3G each define, form, or otherwise include a corresponding impact-absorbing structure 31A, 31B, 31C, 31D, 31E, 31F, 31G shaped and configured to collapse, deform, and/or compress, at least partially, when subjected to impact forces, e.g., those directed towards an adjacent structure or component being protected. In embodiments, the side-impact protection devices 30, 46, 52, 60, 68, 74, 82 shown in FIGS. 3A-3G can be integrated into vehicles, e.g., the vehicle 10 shown in FIGS. 1 and 2. The configurations shown in FIGS. 3A-3G can each impart impact protection, e.g., for an adjacent battery system or other structure, while also doing so in a relatively compact configuration. For example, the configurations shown in FIGS. 3A-3G can be designed to occupy a lateral space of between about 2-12 inches (or between about 5-30 centimeters), e.g., as measured along the transverse axis 7 shown in FIG. 1. In embodiments, this depth can be substantially consistent or variable across a length of the side-impact protection device, e.g., as measured along the longitudinal axis 5 shown in FIG. 1.

Looking now at FIG. 3A, a cross-section of a side-impact protection device 30 attached to an example component/structure 32, e.g., battery system, battery casing, or the like, which forms part of a vehicle is shown, in accordance with embodiments of the present disclosure. For the purposes of explanation, the structure 32 is described as a battery system, e.g., that can be similar to the battery system 20 shown in FIG. 1. However, the impact-protection devices described herein can also be used to protect numerous other structures, systems, and components that are supported under a chassis.

The device 30 includes lateral brackets 34A, 34B. The lateral brackets 34A, 34B are attached to a lateral side 36 of the structure 32. The device 30 also includes a panel 38 or plate, sheet, or other substantially continuous surface, e.g., formed from one or multiple pieces/types of material, that attaches to the lateral brackets 34A, 34B such that the panel 38 extends between the lateral brackets 34A, 34B. The panel 38 in this position can provide a collapsible barrier for the structure 32. The panel 38 can have different configurations, e.g., any of those described herein in connection with FIGS. 5A-5D. The device 30 also includes fairing brackets 40A, 40B that attach to the panel 38 and/or to the lateral brackets 34A, 34B. The fairing brackets 40A, 40B can attach to, and support, a fairing 42, e.g., that can be a panel, cover, housing, shroud or other externally-mounted surface structure. In embodiments, the fairing brackets 40A, 40B can attach to the fairing 42, or can be integrated with the fairing 42. The device 30 is attached to the lateral side 36, but the device 30 can additionally or alternatively be attached to other sides of the structure 32, e.g., its top/bottom surfaces using brackets 44A, 44B.

Looking now at FIG. 3B, a cross-section of another side-impact protection device 46 attached to, enclosing, and protecting the structure 32 is shown, in accordance with embodiments of the present disclosure. The device 46 again includes the lateral brackets 34A, 34B that attach to the lateral side 36 of the structure 32. The device 46 also includes a compartmented structure 48 in place of the panel 38. The compartmented structure 48 is a structure that is configured to facilitate or enhance impact protection, e.g., by providing compartments 50A, 50B, 50C that upon being subject to impact forces can collapse, deform, or compress, at least partially, to thereby absorb, dissipate, distribute, and/or redirect the impact forces. The compartmented structure 48 can have numerous configurations. For example, the compartmented structure 48 can be formed from one or multiple pieces of material shaped to form the compartments, e.g., 50A, 50B, 50C. In FIG. 3B, the compartmented structure 48 is shown as being formed from a single piece of material, e.g., metal or metal alloy that is formed into a desired shape, but can be formed from multiple pieces of material. In embodiments, the compartmented structure 48 can be formed using different manufacturing methodologies, e.g., extrusion, stamping, casting, bending, cutting, or the like. The compartmented structure 48 in FIG. 3B includes particular shapes, numbers of compartments, and relative dimensions; however this is intended to represent only a non-limiting example. The fairing 42 is again attached to the compartmented structure 48 and supported thereon. This attachment can again be provided with fairing brackets 40A, 40B and/or using other attachment structures, e.g., fasteners and the like.

Looking now at FIG. 3C, a cross-section of another side-impact protection device 52 attached to, enclosing, and protecting the structure 32 is shown, in accordance with embodiments of the present disclosure. The device 52 again includes the lateral brackets 34A, 34B that are attached to the lateral side 36 of the structure 32. The device 52 also includes a pair of compartmented structures 54, 56 that are separately formed, e.g., using any of the processes described herein, and assembled/attached together at a junction 58. The formation of separate compartmented structures 54, 56 can allow for simpler, faster, and/or more efficient and cost-effective manufacturing of the components used in the device 52. During assembly, the compartmented structures 54, 56 can be assembled and attached together at the junction 58 (e.g., along corresponding top and bottom edges thereof) using any of the attachment methods described herein (e.g., integrated attachment features, fasteners, welding, and the like). The fairing 42 is again attached to the compartmented structures 54, 56 and supported thereon. This attachment can once again be provided with fairing brackets 40A, 40B and/or using other attachment structures, e.g., fasteners and the like.

Looking now at FIG. 3D, a cross-section of another side-impact protection device 60 attached to the structure 32 is shown, in accordance with embodiments of the present disclosure. The device 60 includes a similar configuration as the device 52 shown in FIG. 3C, e.g., having the lateral brackets 34A, 34B and also similarly formed compartmented structures 62, 64 that are attached together. However, the separately formed compartmented structures 62, 64 are instead configured for attachment along corresponding surfaces thereof at a junction 66 instead of along corresponding top/bottom edges as shown in FIG. 3C. This can simplify manufacturing by allowing smaller compartmented structures to be formed and then combined into a larger compartmented structure capable of greater absorption, dissipation, distribution, and/or re-directing of impact forces in an impact scenario. In addition, while two compartmented structures are shown in each of FIGS. 3C and 3D, more can be provided including combinations of the types shown in FIGS. 3C and 3D. The fairing 42 is again attached to the compartmented structures 62, 64 and supported thereon. This attachment can once again be provided with fairing brackets 40A, 40B and/or using other attachment structures, e.g., fasteners and the like.

Looking now at FIG. 3E, a cross-section of another side-impact protection device 68 attached to the structure 32 is shown, in accordance with embodiments of the present disclosure. The device 68 has a different configuration than the devices 30, 46, 52, 60 in that it is attached/secured through brackets 70A, 70B instead of through lateral brackets 34A, 34B (also shown for depiction purposes). The brackets 70A, 70B can be brackets that hold, affix, or secure the structure 32 (e.g., in one instance being battery system 20) against a chassis or frame of an associated vehicle, e.g., the chassis 14 of the vehicle 10. Or, the brackets 70A, 70B can be brackets used specifically for mounting the device 68, e.g., including compartmented structure 72 and fairing 42, to the structure 32. FIG. 3E again shows the compartmented structure 72 attached to, and supporting, the fairing 42. The compartmented structure 72 is similarly adapted to provide impact protection for the lateral side of the structure 32. The devices 30, 46, 52, 60 shown in FIGS. 3A-3D may, in embodiments, be mounted to the top and bottom surfaces 71, 73 of the structure 32 as shown in FIG. 3E, in addition to, or in the alternative to, being mounted to the lateral side 36 of the structure 32 as presently shown in FIGS. 3A-3D. In other words, with any embodiments herein, each side-impact protection device can be mounted on, against, or to a lateral side, to a top side, and/or to a bottom side of a supported structure (e.g., battery system), and/or to the supporting chassis frame.

Looking now at FIG. 3F, a cross-section of another side-impact protection device 74 attached to the structure 32 is shown, in accordance with embodiments of the present disclosure. The device 74 includes a panel 76 that can be similar in configuration to the panel 38 shown in FIG. 3A. The panel 76 attaches to the lateral side 36 and also to the top and bottom surfaces 71, 73 of the structure 32 via a pair of brackets 78A, 78B that each attach to corresponding brackets 34A, 70A and 34B, 70B, respectively. This configuration allows for additional points of contact and securement against the structure 32, and can help stabilize and secure the components of the device 74 including the panel 76 and the fairing 42. The device 74 also includes brackets 80A, 80B that extend from the panels 76 and/or from the lateral brackets 34A, 34B to the fairing 42 so that the device 74 can support the fairing 42 in a desired position.

Looking now at FIG. 3G, a cross-section of another side-impact protection device 82 attached to the structure 32 is shown, in accordance with embodiments of the present disclosure. The device 82 is configured differently from the devices 30, 46, 52, 60, 68, 74 in that it includes a compartmented structure 84 that is attached directly to the lateral side 36 of the structure 32. This direct attachment can be provided using any of the attachment methods described herein, e.g., fasteners, brackets, welding, and the like. In addition, instead of the fairing 42, the compartmented structure 84 itself forms at least part of an external surface 86, or rather, part of the external profile or outward-facing surface of the associated vehicle, generally speaking. In embodiments, the external surface 86 can be shaped or adapted to define additional features, e.g., such as steps 88, 90. In embodiments, the compartmented structure 84 can be formed from one piece or multiple pieces as described in connection with FIGS. 3A-3D. In embodiments, the compartmented structure 84 can be attached to the lateral side 36 of the structure 32 and/or to the top/bottom surfaces 71, 73 of the structure 32, e.g., as described in connection with FIGS. 3A-3F. In embodiments, the compartmented structure 84 can be attached directly to the lateral side 36, or indirectly, such that there is/are one or more interposed structures (e.g., brackets, enclosures, support elements). The compartmented structure 84 is incorporated such that it defines an inner-facing side that attaches to the structure 32 and an outer-facing side that provides or defines a fairing/external surface.

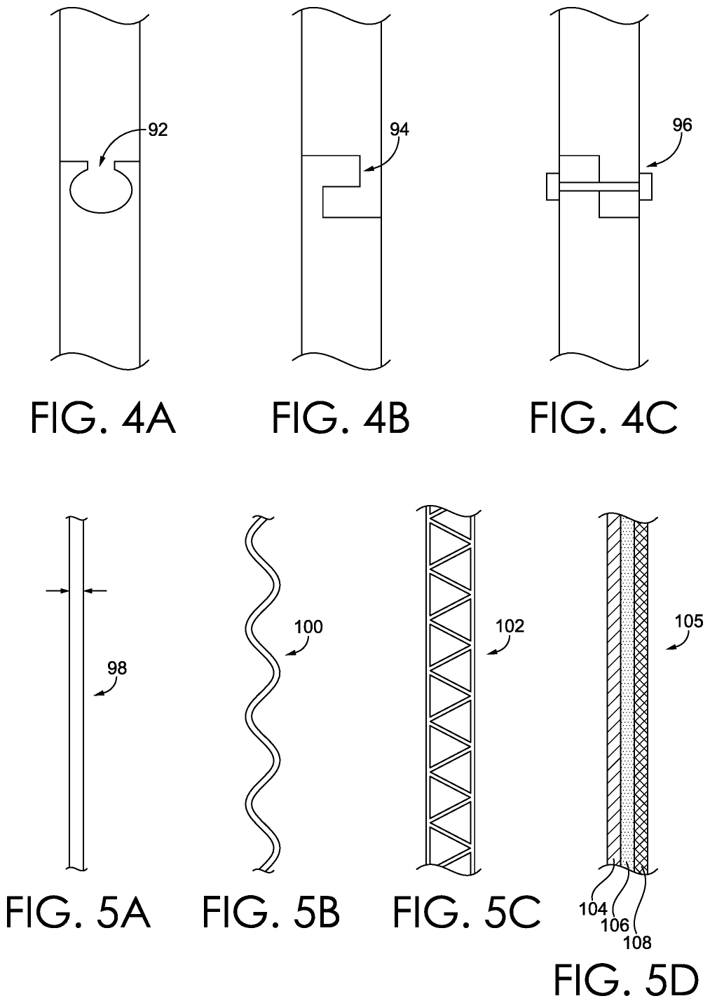

Looking now at FIGS. 4A-4C, a selection of different attachments 92, 94, 96 that can be used to connect pieces of an impact-protection device together are shown, in accordance with embodiments of the present disclosure. The attachments 92, 94 shown in FIGS. 4A and 4B include engaging or interlocking structures that are integrally formed with adjoined pieces of a side-impact protection device, e.g., as shown in FIGS. 1 and 2. For example, looking at FIG. 4A, the attachment 92 is, generally-speaking, a male-female attachment structure in which one piece is shaped to be at least partially received and retained within another piece. In embodiments, a tongue-and-groove connection structure can also be used. In embodiments, a snap-in/snap-out connection structure can be used, e.g., if the attachment 92 includes materials that are capable of elastically deforming to allow insertion of one piece into another piece, and then elastically recovering to an original shape to inhibit detachment through an interference connection. FIG. 4B depicts another attachment 94 that is an interlocking structure, e.g., one in which adjacent pieces have integrally formed portions that are shaped to engage and/or interlock with each other such that the pieces cannot be readily separated in at least one direction/axis or in at least two directions/axes. FIG. 4C depicts another attachment 96 in which adjacent pieces have integrally formed portions shaped to engage each other but are further connected using an additional attaching element, e.g., in this case a fastener, e.g., such as a bolt, screw, or rivet, among other possible attaching elements.

Looking now at FIGS. 5A-5D, a selection of panels 98, 100, 102, 105 configured to form part of an impact-protection device, e.g., a side-impact protection device as described herein, are provided, in accordance with embodiments of the present disclosure. In embodiments, the panels 98, 100, 102, 105 can be formed from metal, metal alloy (e.g., steel or aluminum alloy), polymers, composites, and/or natural materials, among other things. FIG. 5A depicts the panel 98 being formed of a single, solid, unified piece of material, e.g., metal or metal alloy. In embodiments, the panel 98 and others described herein can be between about 1-10 centimeters thick, e.g., as measured between the pair of arrows shown in FIG. 5A, depending on the desired level of tensile strength and rigidity. FIG. 5B depicts another panel 100 but one that includes a non-linear shape, and in particular, a corrugated shape. The corrugated shape can enhance deformation/absorption of impact forces while potentially requiring less material to produce than other impact-absorbing components such as the multi-compartmented structures described herein. FIG. 5C depicts a panel 102 that is formed to include interior cavities/spaces, e.g., configured to at least partially collapse, deform, or compress upon impact to thereby help absorb and dissipate impact forces. FIG. 5D depicts a panel 105 that is formed from multiple layers of material, e.g., in this instance, three layers of material 104, 106, 108. The use of multiple layers of material can allow different types of materials to be combined to provide particular characteristics in a panel, e.g., strength, rigidity, and/or hardness. Three layers of material are depicted in FIG. 5C, but any number may be used, e.g., 2-20 layers, e.g., based on the desired material properties and construction. In embodiments, the layers 104, 106, 108 can be the same material, or can be different materials, e.g., with different material properties such as strength or ductility. The strength of materials can be determined using an ASTM test performed under substantially the same testing conditions, e.g., such as ASTM A370, and ductility can be determined using an ASTM test performed under substantially the same testing conditions, e.g., such as ASTM E290.

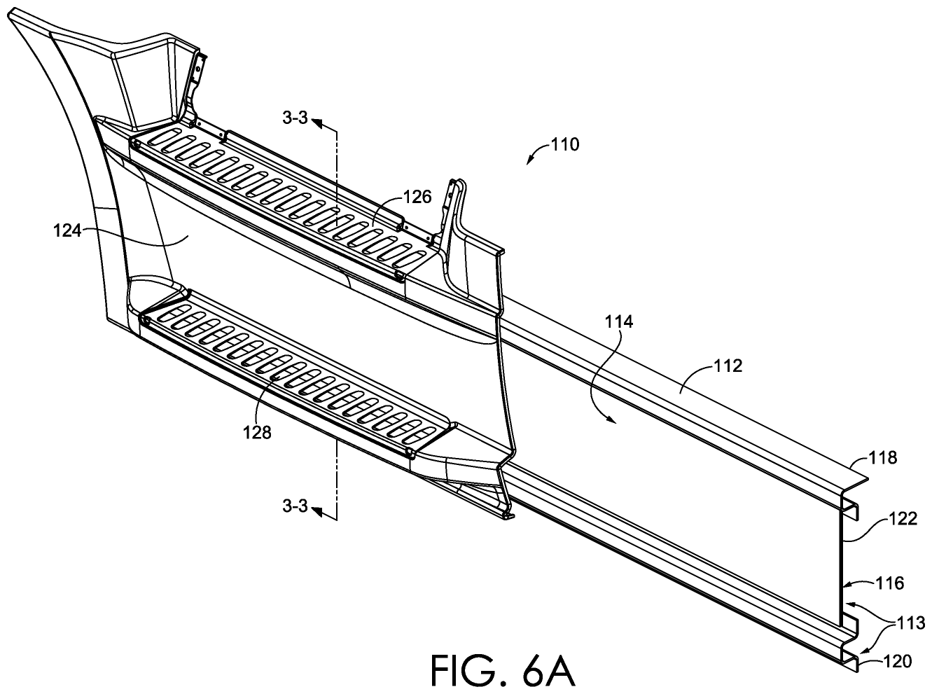

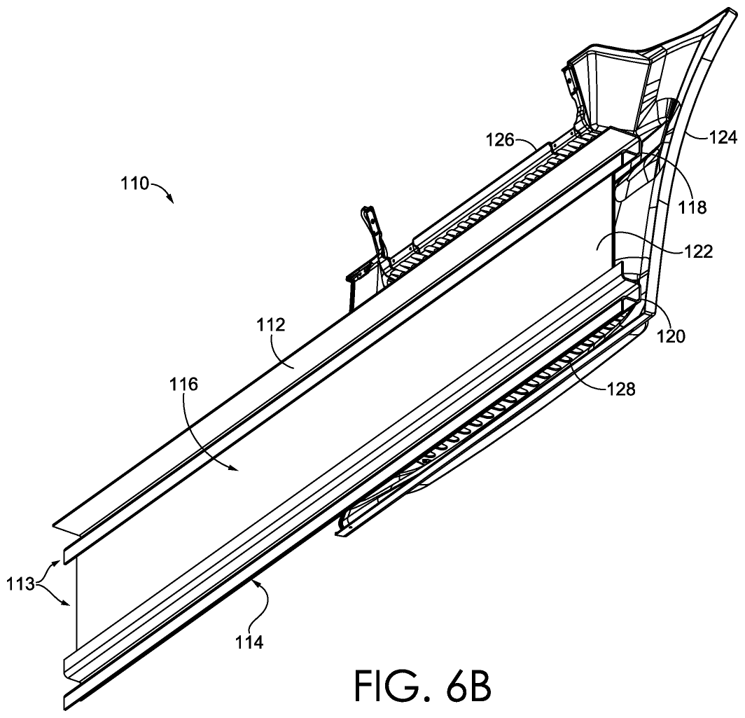

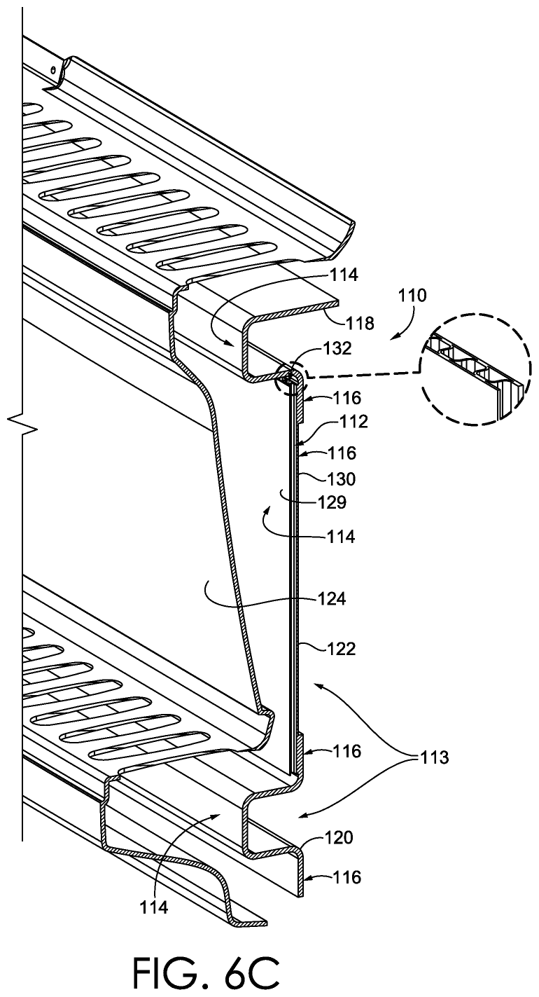

Looking now at FIGS. 6A and 6B, different perspectives of a side-impact protection assembly 110 that can be integrated onto a lateral side of a vehicle, e.g., the vehicle 10 shown in FIG. 1, are provided, in accordance with embodiments of the present disclosure. FIG. 6C in addition shows a cross-section of the assembly 110 viewed along cut line 3-3 identified in FIG. 6A. The assembly 110 includes a side-impact protection device 112 that has an outer-facing side, section, and/or surface 114, e.g., that generally faces away from an associated vehicle, and an inner-facing side, section, and/or surface 116, e.g., that generally faces towards an associated vehicle, as shown in FIGS. 6A and 6B. The side-impact protection device 112 is configured so that it forms or provides an impact-absorbing structure 113, e.g., located substantially between the side 114 and the side 116, which during an impact scenario can at least partially absorb, dissipate, distribute, and/or re-direct impact forces, e.g., by collapsing, deforming, or compressing towards a component or structure it is protecting. The impact-absorbing structure 113 is configured so that it occupies a limited amount of lateral space, e.g., allowing it to protect a larger, wider component. This can include a component that is equal to or wider than a chassis supporting the component.

The side-impact protection device 112 can have different configurations. For example, in embodiments, the side-impact protection device 112 can be formed of a single, solid, unified, and/or integral piece, e.g., one formed with a continuous manufacturing operation such as molding, casting, extrusion, or the like. Or, in embodiments, the side-impact protection device 112 can be formed of multiple pieces that are manufactured, assembled, and then attached together, e.g., as shown in FIGS. 6A and 6B. In such embodiments, the pieces can be formed using similar manufacturing processes, e.g., molding, casting, extrusion, cutting, bending, stamping, and the like, and then the pieces can be assembled and attached together using a suitable attachment method/implement, e.g., fasteners, welding, bonding, coupling of matable structures that are integrally formed on the pieces, or the like.

The side-impact protection device 112 includes a pair of brackets 118, 120. In the depicted embodiment, each bracket 118, 120 is an elongated structure suitable for being attached/secured to or against a lateral side of a battery or other supported component, to or against a support structure for the same, and/or to or against a chassis of an associated vehicle, among other things. The pair of brackets 118, 120 can each be formed of substantially rigid materials such as metal, metal alloy, rigid composites, and the like, or a combination thereof.

The side-impact protection device 112 further includes a panel 122. The panel 122 is sized, shaped, and configured to be attached to the bracket 118 and to the bracket 120 such that the panel 122 extends therebetween. This configuration provides a number of benefits. For example, it allows compartmented areas to be formed, e.g., those at least partially enclosed by the device 112 itself, or those at least partially enclosed between the device 112 and adjacent structures against which the device 112 is attached/mounted. It also allows the device 112 to provide a collapsible area that can absorb and dissipate impact forces encountered during an impact scenario. To state it differently, similar to front/rear bumpers on a car/truck, the compartments formed by the device 112 in embodiments can provide a collapsible “crumple zone” that can absorb, dissipate, and deflect forces as opposed to allowing such forces to travel directly to the adjacent vehicle component/structure. The panel 122 can have different configurations including any of those described in connection with FIGS. 5A-5D herein. In embodiments, the panel 122 can be a single, unified flat panel, e.g., an aluminum or steel sheet with a thickness of between about 0.01-0.5 inches or between about 2-30 millimeters. In embodiments, the materials and construction of the brackets 118, 120 and the panel 122 can be selected to provide a desired level of impact protection (e.g., tensile strength) suitable for the forces that can be encountered in an impact-scenario, e.g., in accordance with regulatory standards.

The side-impact protection device 112 in addition to providing impact protection is configured to support a fairing 124. The fairing 124 is a structure that forms part of an exterior profile along, aside, and/or adjacent to a vehicle chassis and/or vehicle underbody, as shown in FIGS. 6A and 6B. The fairing 124 has an aerodynamic profile. Or rather, the fairing 124 has an exterior-facing surface that enhances aerodynamic flow and reduces aerodynamic drag. The fairing 124 can include surface contours that help streamline flow, e.g., increasing laminar flow and reducing turbulent flow, during use. The fairing 124 can also formed such that it defines, incorporates, and/or provided a pair of steps 126, 128.

FIG. 6B also depicts the side-impact protection device 112 but from a perspective that shows more detail of the inner-facing side or surface 116. FIG. 6B again shows the panel 122 and the brackets 118, 120. FIG. 6B depicts how these elements 118, 120, 122 are assembled together to form a relatively shallow configuration (e.g., as measured along a lateral direction, e.g., direction 7 identified in FIG. 1). The assembled elements 118, 120, 122 are shaped and sized to fit between the fairing 124 and the adjacent protected structure. In other words, the assembled elements 118, 120, 122 form an impact-absorbing structure 113 that is between about 1-12 inches (or between about 1-30 centimeters) in lateral depth (e.g., as measured between the inner-facing side or surface 114 and the outer-facing side or surface 116) along at least part of a length of the device 112.

FIG. 6C depicts a cross-section of the assembly 110 and the side-impact protection device 112 shown in FIGS. 6A and 6B. FIG. 6C more clearly shows how the elements 118, 120, 122 are assembled together to form the impact-absorbing structure 113 under the fairing 124. It can also be seen how the configuration of the side-impact protection device 112 helps limit the amount of space required for the device 112 under the fairing 124. This, in turn, leaves more space for the adjacent structure/component being protected thereby permitting that structure/component to be larger, while still being enclosed and protected by a suitable impact protection structure. To provide one example, a battery system for an electric vehicle, e.g., an electric freight truck, can be enclosed and protected despite the space that might be required for such a component (e.g., substantially the entire width of an associated chassis or more).

In FIG. 6C, the configuration of the panel 122 is shown. The panel 122 includes a surface or side 129 (e.g., that is substantially planar) and an opposite surface or side 130 (e.g., that is substantially planar) and also includes an interposed structure 132 that is non-planar, e.g., corrugated, compartmented, or the like. The device 112 is configured so that it can be attached directly against a lateral side or surface of a supported component (e.g., battery system, or the like) and so that the pieces of the device 112 provide collapsible compartments that can absorb impact forces. FIG. 6C shows the elements 118, 120, 122 having generic connections, attachments, and/or couplings. In embodiments, the elements 118, 120, 122 can be attached using fasteners (e.g., bolts, screws, rivets, pins, and the like) or using welding, bonding, adhering, or similar processes. The elements 118, 120, 122 of the device 112 can also be attached to an adjacent lateral side, surface, or frame using similar attachment methods.

The construction of the side-impact protection device 112 from a plurality of smaller pieces can provide multiple benefits. For example, it can allow for simplified and lower-cost manufacturing as it only requires smaller, more compact, and more easily manufactured pieces to be produced, e.g., compared to a larger integral piece that could be more complex, costly, and time-consuming to manufacture, transport, and integrate. In addition, the use of smaller distinct pieces (e.g., elements 118, 120, 122) means that numerous configurations of a side-impact protection device adapted for a particular use can be produced. Rather, distinct pieces can be used to accommodate the particular shape, size, and space occupied by an adjacent structure that is to be protected from impact forces, e.g., battery system, fuel tank, electric motor, or the like. In contrast to using larger integrated pieces, this can reduce requirements for unique tooling.

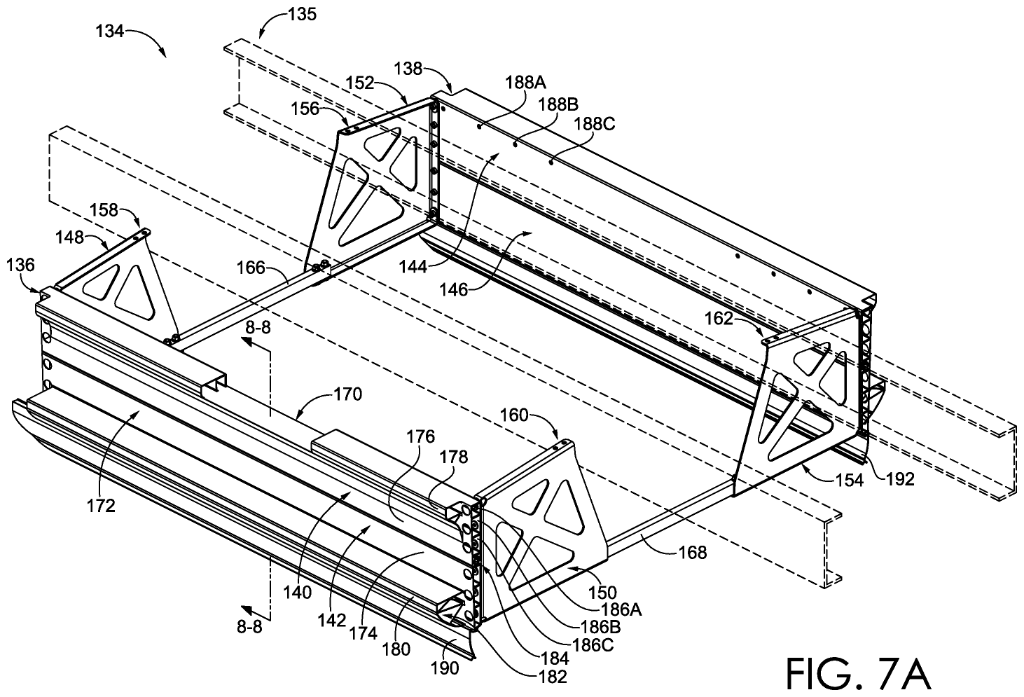

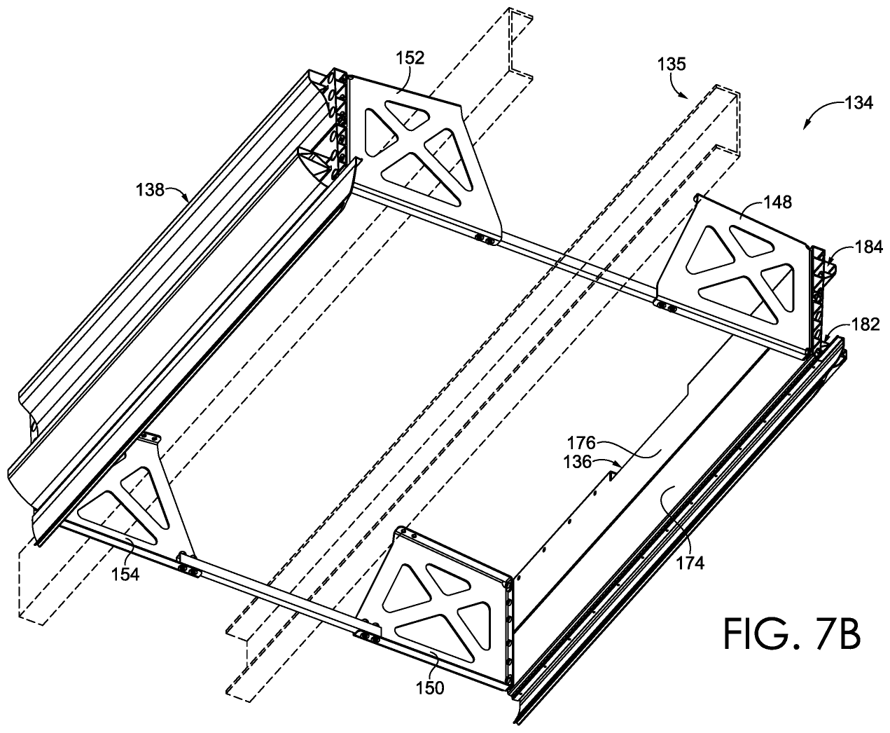

Looking now at FIGS. 7A and 7B, a side-impact protection system 134 for a vehicle, e.g., the vehicle 10 in FIG. 1, depicted generally from opposite perspectives and in isolation is shown, in accordance with embodiments of the present disclosure. The system 134 is configured so that it can be attached at least partially around, against, and/or onto a structure/component supported on, under, and/or adjacent to a chassis of a vehicle, e.g., the vehicle 10 shown in FIG. 1. The system 134 includes a pair of side-impact protection devices 136, 138 that can be mounted on opposite sides of the protected structure/component (e.g., in this case the battery system 20).

The side-impact protection devices 136, 138 shown in FIGS. 7A and 7B each have a similar configuration. In addition, each side-impact protection device 136, 138 is assembled from a plurality of sub-pieces, e.g., 140, 142 and 144, 146 (among other possible sub-pieces not identified). The sub-pieces 140, 142 and 144, 146 are assembled and attached together, and then attached/mounted to the structure to be protected and/or to a chassis frame 135. The attachment/mounting of the devices 136, 138 can be accomplished in different fashions. For example, in embodiments, the devices 136, 138 can be attached to corresponding lateral sides or surfaces of the component to be protected, e.g., directly or indirectly, e.g., using any of the attachment methods described herein. In embodiments, additional attachments can be used, e.g., as shown in FIGS. 7A and 7B. For example, with the system 134 a pair of brackets 148, 150 and 152, 154 are attached at opposite ends of each of the side-impact protection devices 136, 138 as shown in FIGS. 7A and 7B. The brackets 148, 150, 152, 154 each extend along either the forward or rearward part of the supported component (e.g., battery system) and in embodiments can be attached thereto, e.g., at attachment points 156, 158, 160, 162, and/or others. In embodiments, the pair of brackets 148, 150 and 152, 154 can further be connected via support rails 166, 168 as shown in FIGS. 7A and 7B. These connections can help secure and stabilize the position of the devices 136, 138.

The side-impact protection devices 136, 138 are integrated along opposite lateral sides of the protected component (not shown for clarity) and do so while occupying only a limited amount of lateral space adjacent to the protected component. For the purposes of explanation, the device 136 will be described, but it should be understood that the device 138 has a similar configuration. The device 136 includes an inner-facing side or section 170 and an outer-facing side or section 172. The side-impact protection device 136 is formed from a piece 174, e.g., an elongated portion or structure that generally forms a bottom part of the device 136, and a piece 176, e.g., an elongated portion or structure that generally forms an upper portion of the device 136. The side-impact protection device 136 can be configured so that it forms part of an exterior profile of the associated vehicle. For example, it can be seen that the device 136 includes steps 178, 180. These can be either integrally formed features or attached features. For example, in embodiments, the steps 178, 180 can be integrally formed during the manufacturing process used to produce the pieces 174, 176. The geometry of the steps 178, 180 can also form internal compartments, e.g., such as compartments 182, 184, that increase impact-absorption capability/capacity.

In embodiments, the pieces 174, 176 can be attached to the brackets 148, 150, e.g., using fasteners installed at points 186A, 186B, 186C, and/or at other points not identified for clarity and simplicity purposes. In embodiments, the pieces 174, 176 can also be attached to (e.g., directly against) the protected structure, e.g., using fasteners installed at points 188A, 188B, 188C, and/or at other points not identified for clarity and simplicity purposes. The side-impact protection device 138 may be assembled and attached similarly. The side-impact protection devices 136, 138 each include an elongated mini-fairing 190, 192 that extends the profile of the side-impact protection devices 136, 138 to help enhance aerodynamic performance and provide further enclosure of the protected component/structure.

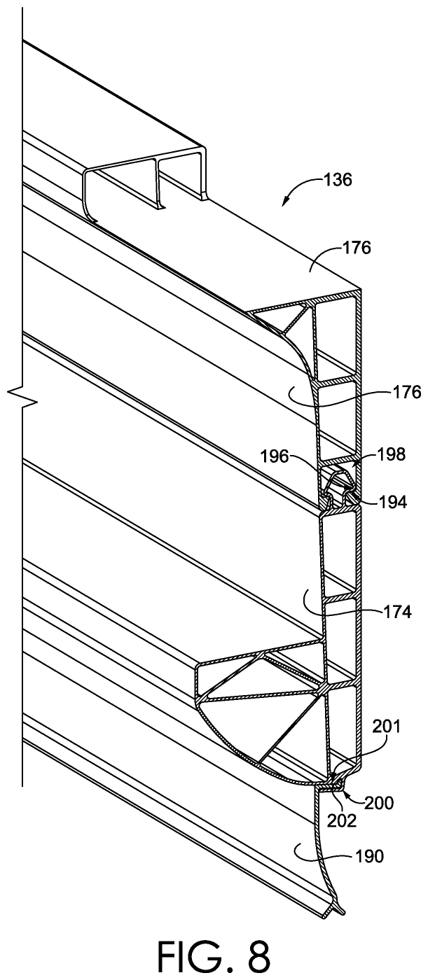

The sub-pieces that form the devices 136, 138 can be produced using the manufacturing processes described herein, e.g., extrusion, casting, molding, stamping, bending, cutting, and the like. In addition, the pieces 174, 176 can be attached together using different attachment methods including connection of integrally-formed attachment structures. FIG. 8 shows a cross-section of the side-impact protection device 136 viewed along cut-line 8-8 identified in FIG. 7A. FIG. 8 depicts in particular how the pieces assembled together to form the side-impact protection device 136 can be reversibly attached, secured, connected, and/or joined using the structures integrally formed on the pieces (e.g., during the associated manufacturing process). This can simplify tooling and assembly.

Looking at FIG. 8, it can be seen that the pieces 174, 176 are connected together with a mechanical attachment 194. This mechanical attachment 194 includes an interlocking structure 196 (e.g., protrusion that forms a male-type part) on piece 174 and includes an interlocking structure 198 (e.g., recess that forms a female-type part) on piece 176. The interlocking structure 196 can be inserted into the interlocking structure 198 such that it is retained or constrained from moving in at least two axes of movement. This enables reversibly securing the components together with limited need for additional tooling or attachments (e.g., fasteners, welding, and the like) although in embodiments these can also be used for additional securement. Looking at FIG. 8, the mini fairing 190 is attached to the piece 174 using a similar mechanical attachment 200 that is differently shaped but also integrally formed in the adjacent pieces 174, 190 and capable of reversibly connecting the components together like the mechanical attachment 194. The mechanical attachment 200 includes an extension 202 that is part of the mini-fairing 190 and a recess 201 that is formed in the piece 174 and that is shaped to receive the extension 202 such that it is retained or constrained from moving in at least two axes of movement. This enables reversibly securing the components together with limited need for additional tooling and attachments (e.g., fasteners, welding, and the like) although in embodiments these can be used for additional securement.

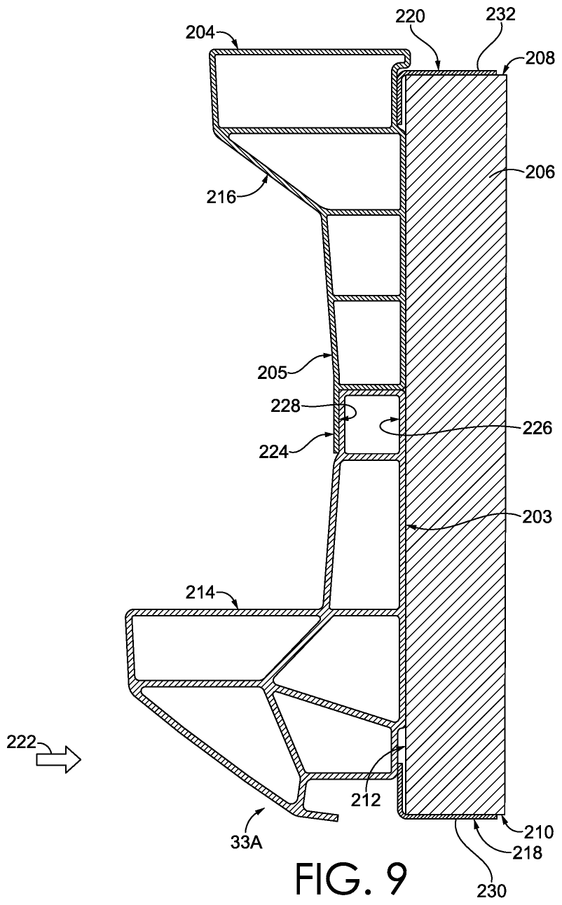

Looking now at FIGS. 9-15, a series of cross-sections showing differently configured side-impact protection devices are provided, in accordance with embodiments of the present disclosure. The side-impact protection device cross-sections shown in FIGS. 9-15 represent unique configurations that can provide the benefits described herein, e.g., including a desired level of impact-protection, simplified manufacturing, transportation, and installation, and reduced need for lateral accommodating space, among other benefits. Each side-impact protection device shown in FIGS. 9-15 includes, defines, or otherwise provides an impact-absorbing structure 33A, 33B, 33C, 33D, 33E, 33F, 33G that is shaped and configured so that it can collapse, deform, and/or compress, at least partially, when subjected to impact forces, e.g., those directed towards an adjacent structure or component being protected.

Looking now at FIG. 9, a cross-section of a side-impact protection device 204 is shown, in accordance with embodiments of the present disclosure. The side-impact protection device 204 is attached to and/or against a component and/or structure 206. The component/structure 206 can be one that is supported on a vehicle, e.g., on, under, and/or adjacent to the chassis thereof. In embodiments, the component/structure 206 can be a battery system, e.g., one configured to provide power to an electric powertrain, or can be another component of an associated vehicle. The component/structure 206 includes a top surface 208, a bottom surface 210, and a lateral side or surface 212. The side-impact protection device 204 is configured to be attached, mounted on, and/or secured against at least the lateral side or surface 212.

The side-impact protection device 204 includes an inner-facing side or surface 203 and an outer-facing side or surface 205. The inner-facing side or surface 203 attaches to and/or against the lateral side or surface 212 of the structure 206. In this embodiment, the outer-facing side or surface 205 forms part of an exterior surface or profile of the associate vehicle. The side-impact protection device 204 is formed as an assembly of distinctly-formed pieces 214, 216, 218, 220. The pieces 214, 216, 218, 220 can be formed from metal, metal alloy, composites, polymeric materials, or a combination thereof as described in connection with embodiments herein. The pieces 214, 216, 218, 220 can also be formed using the manufacturing processes described herein, e.g., extruding, casting, molding, stamping, bending, cutting, and the like. In one embodiment, the pieces 214, 216, 218, 220 can in particular be formed using metal extrusion.

The pieces 214, 216 form the main body of the side-impact protection device 204 and are configured to absorb, dissipate, distribute, and/or re-direct impact forces and in particular those imparted along the direction of arrow 222 shown in FIG. 9. In addition, the pieces 214, 216 are configured to be connected together at a junction 224. To facilitate this connection, the pieces 214, 216 include integrally-formed structures 226, 228. The integrally-formed structures 226, 228 can be engaged by inserting the structure 226 into the structure 228 as shown in FIG. 9. In order to remain engaged, the integrally-formed structures 226, 228 may have a friction or interference fit with each other, or may be attached together using fasteners, welding, bonding, or other attachment methods. By having integrally-formed structures that are matable with each other, e.g., like structures 226, 228, manufacturing and assembly of the device 204 can be simplified by limiting the number of elements required to connect the pieces together.

The side-impact protection device 204 attaches against the lateral side or surface 212 of the structure 206. This attachment is provided at least in part by a pair of brackets 230, 232 that secure the device 204 and the structure 206 together. The brackets 230, 232 in particular are attached to the inner-facing side or surface 203 of the device 204, and to top/bottom surfaces 208, 210 of the component/structure 206. In embodiments, the brackets 230, 232 can be additionally attached to the lateral side or surface 212, or in embodiments, can be solely attached to the lateral side or surface 212 instead of to the top/bottom surfaces 208/210 of the structure 206. The brackets 230, 232 are represented as L-shaped brackets, but can have other shapes that facilitate attaching/securing the adjacently mounted structures together. The brackets 230, 232 can be attached to the adjacent structures 204, 206 using fasteners, welding, adhering, or other attachment methods. In addition to the brackets 230, 232, other elements may be used, alternatively or in addition, to secure the device 204 to the lateral side or surface 212. For example, in embodiments, fasteners can be inserted through the pieces 214, 216 into the lateral side or surface 212 to thereby secure the device 204 against the lateral side or surface 212.

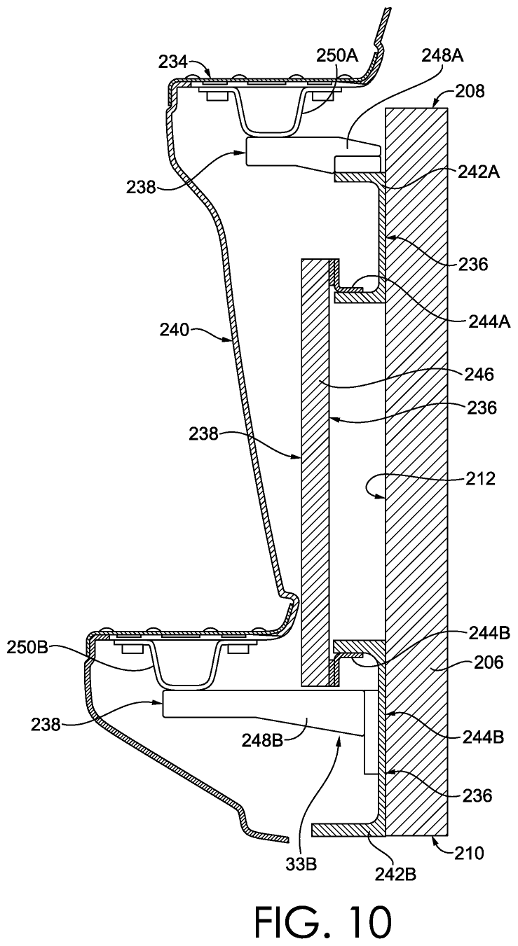

Looking now at FIG. 10, a cross-section of another side-impact protection device 234 is shown, in accordance with embodiments of the present disclosure. The device 234 is once again attached to the structure 206. The device 234 is also once again assembled from a plurality of distinctly-formed pieces. The device 234 includes an inner-facing side or surface 236. The inner-facing side or surface 236 is attached against the lateral side or surface 236 of the structure 206, such that at least a portion of the inner-facing side or surface 236 is abutted against the lateral side or surface 236 as shown in FIG. 10. The device 234 also includes an outer-facing side or surface 238. The outer-facing side or surface 238 is attached to, and supports, a fairing 240, such that the fairing 240 is maintained in a supported position.

The device 234 includes a relatively compact configuration of components that allow it to fit between the other existing structures mounted on an associated vehicle, e.g., the structure 206 and the fairing 240 shown in FIG. 10. To enable this, the device 234 includes a pair of brackets 242A, 242B that are attached to the structure 206, and also includes a pair of brackets 244A, 244B that are attached to the brackets 242A, 242B and that are also attached to a panel 246. The panel 246 can have any of the configurations described herein in connection with FIGS. 5A-5D. For example, the panel 246 can be formed from a single sheet of material, from multiple sheets of material, from a single material, from multiple materials, can be flat, corrugated, compartmented, or some combination thereof, among other configurations.

The panel 246 is spaced from the lateral side or surface 212, and is supported in its position by the brackets 242A, 242B, 244A, 244B. The panel 246 in this position provides a structure that can collapse or deform when subjected to impact forces, thereby allowing it to absorb, dissipate, and/or re-direct such forces instead of allowing those forces to transfer directly to the lateral side or surface 212. The device 234 also includes brackets 248A, 248B that are attached to the brackets 242A, 242B. The brackets 248A, 248B extend outward from the lateral side or surface 212 and support the fairing 240 by attaching to brackets 250A, 250B that are attached to the fairing 240. The device 234 thus provides the additional function of supporting the fairing 240 in a substantially fixed position, allowing it to function as part of an exterior profile of the associated vehicle. In embodiments, the brackets 250A, 250B may be omitted, and the fairing 240 may be attached directly to other elements of the device 234. The pieces that are assembled together to form the device 234 can be manufactured and connected together using any of the manufacturing and attachment processes described herein.

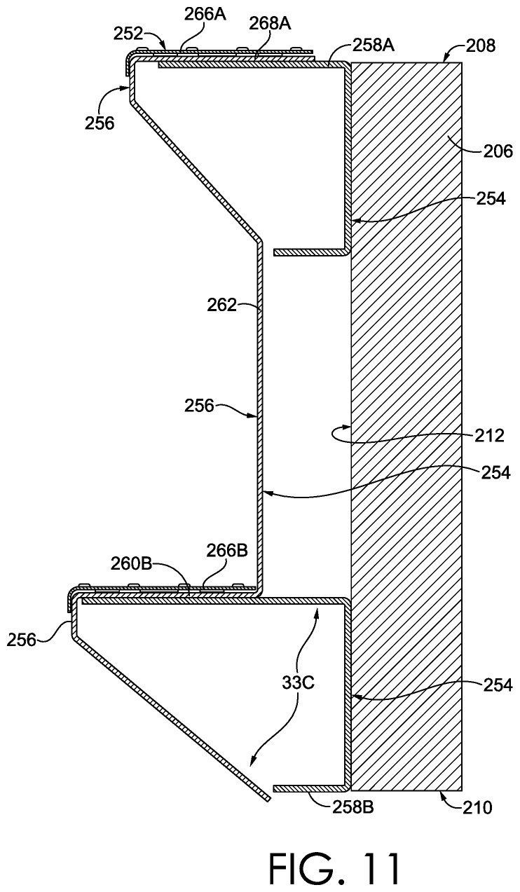

Looking now at FIG. 11, a cross-section of another side-impact protection device 252 is shown, in accordance with embodiments of the present disclosure. The device 252 is once again secured to and/or against the structure 206. The device 252 is also once again assembled from a plurality of distinctly-formed pieces although fewer than what is shown in FIGS. 9 and 10. The device 252 includes an inner-facing side or surface 254. The device 252 also includes an outer-facing side or surface 256. In FIG. 11, it can be seen that at least part of the inner-facing side or surface 254 is attached against the lateral side or surface 212 of the structure 206. The outer-facing side or surface 256 forms part of the exterior profile of the associated vehicle. The device 252 includes a pair of brackets 258A, 258B that are attached to and/or against the lateral side or surface 212 of the structure 206, e.g., using any of the attachment processes described herein. FIG. 11 depicts the brackets 258A, 258B attached directly to the component/structure 206. However, in embodiments, one or more interposed elements may be included, e.g., to increase reinforcement and stability, and/or to accommodate particular mounting requirements of the structure 206. The device 252 also has a compartmented structure 262 that is attached to the brackets 258A, 258B. The compartmented structure 262 is adapted to provide impact protection by being collapsible/deformable when subjected to impact forces as described herein. The compartmented structure 262 is also shaped to include or support steps 260A, 260B. In embodiments, additional reinforcing material/grating 266A, 266B can be coupled to the steps 260A, 260B both for reinforcement and to enhance traction thereon. The pieces that are assembled together to form the device 252 can be manufactured and connected together using any of the manufacturing and attachment processes described herein.

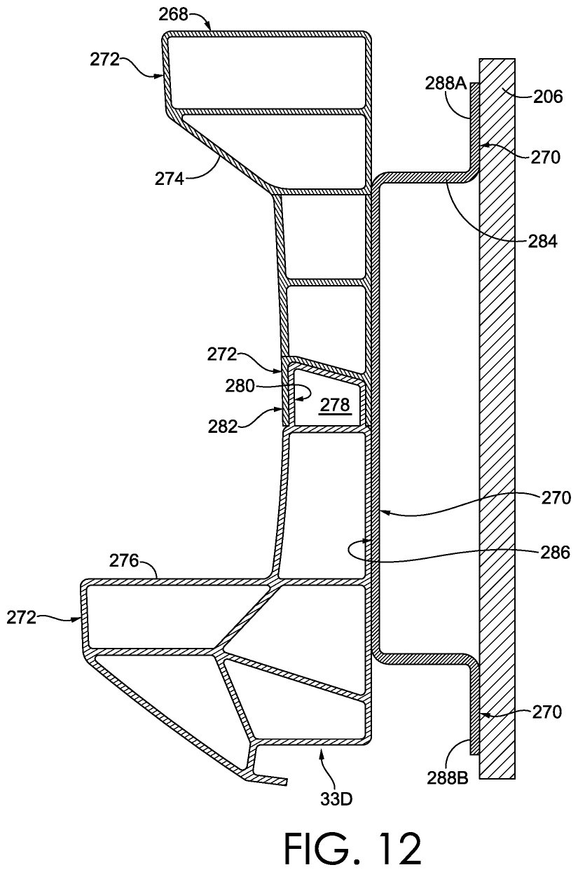

Looking now at FIG. 12, a cross-section of another side-impact protection device 268 is shown, in accordance with embodiments of the present disclosure. The device 268 is once again secured to and/or against the structure 206. The device 268 is also once again assembled from a plurality of distinctly-formed pieces. The device 268 includes an inner-facing side or surface 270. The device 268 also includes an outer-facing side or surface 272. The device 268 includes pieces that form a compartmented structure 274 and a compartmented structure 276 that are connected together with an attachment 278. To form the attachment 278, an integrally-formed structure 280 on the compartmented structure 276 is inserted into an integrally formed structure 282 on the compartmented structure 274 to thereby form a connection. To enhance the stability of the connection, a friction fit or interference fit of the structures 280, 282 may be used, or the structures 280, 282 can be additionally secured using fasteners, welding, adhering, bonding, or the like. The compartmented structures 274, 276 each provide impact protection, e.g., through being collapsible, deformable, or compressible, at least partially, when subjected to impact forces, and are also be shaped to form an exterior profile or surface of the associated vehicle. In FIG. 12, the compartmented structures 274, 276 are attached to a single, larger, non-linear bracket 284 that includes a mounting surface 286 to which the compartmented structures 274, 276 are attached, e.g., using any of the attachment methods described herein. The bracket 284 includes extensions 288A, 288B that can be attached to the lateral side or surface 212 of the structure 206, e.g., using any of the attachment methods described herein. The bracket 284 is configured so that in addition to securing the compartmented structures 274, 276 to the lateral side or surface 236 and supporting them in spaced-relation with the lateral side or surface 236, the non-linear shape of the bracket 284 may also provide some degree of collapsibility/deformability that can further facilitate impact absorption. The pieces that are assembled together to form the device 268 can be manufactured and connected together using any of the manufacturing and attachment processes described herein.

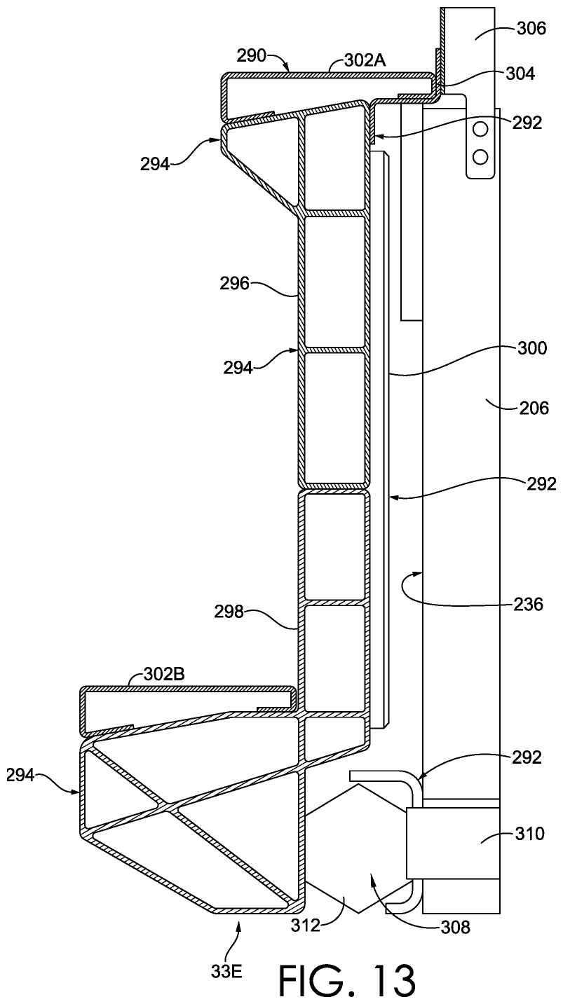

Looking now at FIG. 13, a cross-section of another side-impact protection device 290 is shown, in accordance with embodiments of the present disclosure. The device 290 is once again secured to and/or against the structure 206. The device 290 is also once again assembled from a plurality of distinctly-formed pieces. The device 290 includes an inner-facing side or surface 292. The device 290 also includes an outer-facing side or surface 294 that forms part of the external profile of an associated vehicle. The device 290 includes a compartmented structure 296 and a compartmented structure 298 that are attached to a panel 300. The panel 300 at least in part connects the compartmented structures 296, 298 together in fixed relation. The compartmented structures 296, 298 provide impact absorption, e.g., through being collapsible, deformable, or compressible, at least partially, when subjected to impact forces. There are in addition brackets 302A, 302B attached to the compartmented structures 296, 298 that also form steps and enable further impact absorption. The compartmented structures 296, 298, the panel 300, and the brackets 302A, 302B are secured to the structure 206 via brackets 304, 308. The bracket 304 attaches an upper portion of the device 290 to support 306 used to hold/support the structure 206 in place, e.g., under a chassis or frame. The bracket 308 attaches a lower portion of the device 290 to support 310 also used to hold/support the structure 206 in place, e.g., under a chassis or frame. The bracket 308 also includes an extended portion 312 that can collapse, deform, or compress, at least partially, when subjected to impact forces and thus enhance impact protection. The pieces that are assembled together to form the device 290 can be manufactured and connected together using any of the manufacturing and attachment processes described herein.

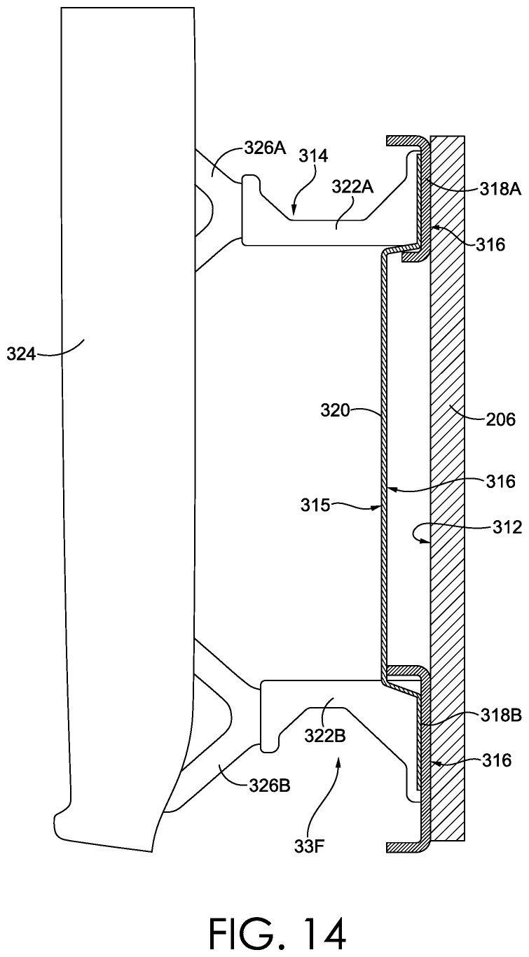

Looking now at FIG. 14, a cross-section of another side-impact protection device 314 is shown, in accordance with embodiments of the present disclosure. The device 314 is once again attached to and/or against the structure 206. The device 314 is also once again assembled from a plurality of distinctly-formed pieces that can be formed using any of the manufacturing processes described herein. The device 314 includes an outer-facing side or surface 315 and an inner-facing side or surface 316. The inner-facing side 316 is attached to the lateral side or surface 212 of the structure 206 as shown in FIG. 14. To provide this connection, the device 314 includes a pair of brackets 318A, 318B that are attached to the lateral side or surface 212. The device 314 also includes a panel 320 that is attached to the brackets 318A, 318B such that the panel 320 extends between the brackets 318A, 318B and is maintained in spaced-relation with the lateral side or surface 212. The panel 320 can have any of the configurations described herein, e.g., those described in connection with FIGS. 5A-5D. The panel 320, being positioned in spaced relation with the lateral side or surface 212, can collapse or deform when subjected to impact forces, and thus help limit those forces from being transferred directly to the lateral side or surface 212. The device 314 also includes a pair of brackets 322A, 322B that are attached to the panel 320 and indirectly to the brackets 318A, 318B as shown in FIG. 14. The brackets 322A, 322B extend outward to a pair of Y-shaped brackets 326A, 326B that attach to, and support, a fairing 324. The pieces that are assembled together to form the device 314 can be manufactured and connected together using any of the manufacturing and attachment processes described herein.

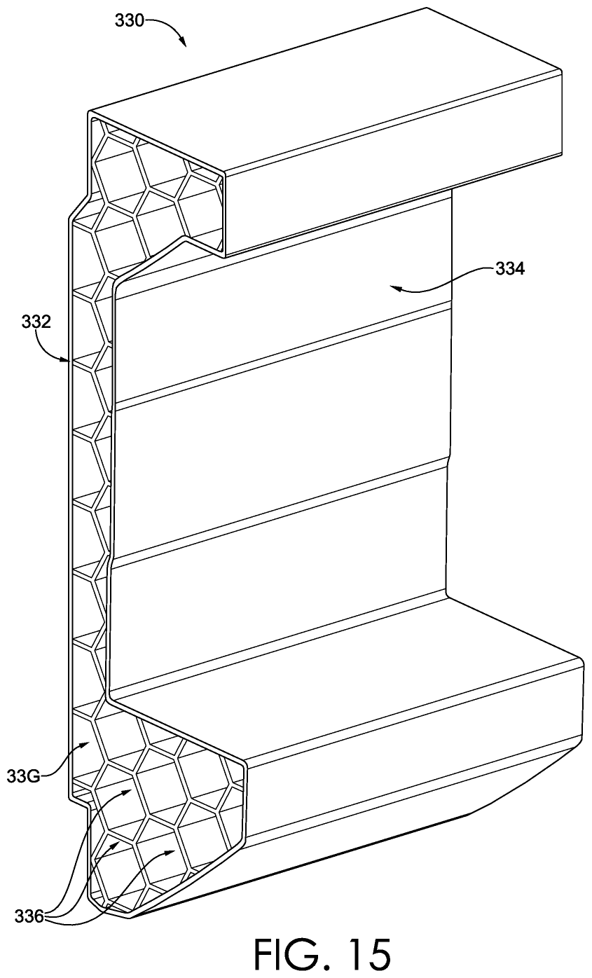

Looking now at FIG. 15, a cross-section, perspective view of a side-impact protection device 330 having a particular internal configuration suitable for absorbing, dissipating, and/or re-directing impact forces is shown, in accordance with embodiments of the present disclosure. The side-impact protection device 330 includes an inner-facing side or surface 332, an outer-facing side or surface 334, and a honeycomb structure 336 that is located between the side or surface 332 and the side or surface 334. The honeycomb structure 336 includes a plurality of hexagonally-shaped compartments (including those that are full hexagonal shapes and partial hexagonal shapes). The hexagonally-shaped compartments of the honeycomb structure 336 can collapse, deform, or compress, at least partially, when subjected to impact forces and thus help reduce such forces from being transferred to a structure against which the side or surface 332 is positioned. In FIG. 15 the side-impact protection device 330 is shown as a single, integral structure, e.g., being formed in unified fashion using a suitable manufacturing process, e.g., such as extrusion. However, the side-impact protection device 330 can also be formed from multiple pieces that are distinctly formed, assembled, and attached together using any of the processes described herein.

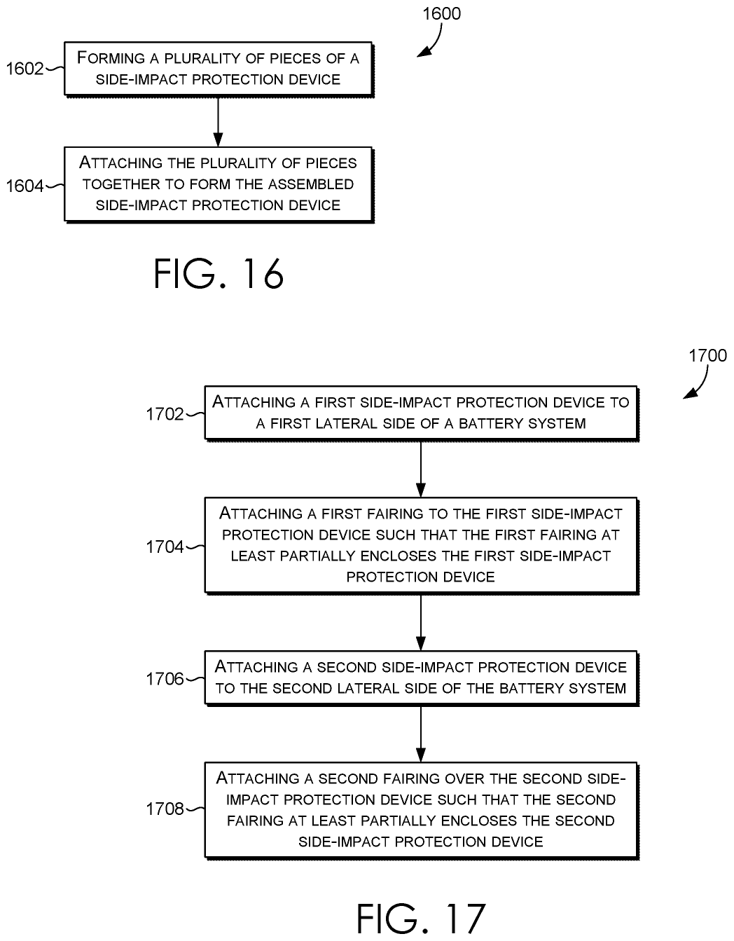

Looking now at FIG. 16, a block diagram of a method 1600 of manufacturing a side-impact protection device, e.g., such as the devices 22A or 22B shown in FIG. 2 or others described herein, is provided, in accordance with embodiments of the present disclosure. The method 1600 includes blocks 1602-1604, but is not limited to this selection of elements, or the order depicted. In block 1602, the method 1600 includes forming a plurality of pieces of an impact-protection device. The pieces can be formed using any of the manufacturing processes described herein, e.g., extrusion, casting, molding, stamping, bending, cutting, additive manufacturing (e.g., 3-D printing), subtractive manufacturing (e.g., machining such as electrical discharge machining (“EDM”)), or the like. The pieces can also be shaped, sized, and configured to be assembled and attached together using any of the attachment methods described herein, e.g., joining of integrally-formed structures, fasteners, welding, or the like. In block 1604, the method 1600 includes attaching the pieces together to form an assembled side-impact protection device, e.g., such as any of the devices shown in FIGS. 1-15.

Looking now at FIG. 17, a block diagram of a method 1700 of integrating a side-impact protection system, e.g., the system 134 shown in FIGS. 7A and 7B, into an electric vehicle, e.g., the vehicle 10 shown in FIG. 1, is provided, in accordance with embodiments of the present disclosure. The method 1700 includes blocks 1702-1708, but is not limited to this selection of elements, or the order depicted. In block 1702, the method 1700 includes attaching a first side-impact protection device, e.g., the device 136 shown in FIG. 7A, to a first lateral side of a battery system, e.g., the lateral side 13 of the battery system 20 shown in FIG. 2. In block 1704, the method 1700 includes attaching a first fairing, e.g., the fairing 28A shown in FIG. 2, to the first side-impact protection device such that it at least partially encloses the first side-impact protection device. In block 1706, the method 1700 includes attaching a second side-impact protection device, e.g., the device 138 shown in FIG. 7A, to the second lateral side of the battery system, e.g., the lateral side 15 of the battery system 20 shown in FIG. 1. In block 1708, the method 1700 includes attaching a second fairing, e.g., the fairing 28B shown in FIG. 2, over the second side-impact protection device such that it at least partially encloses the second side-impact protection device.

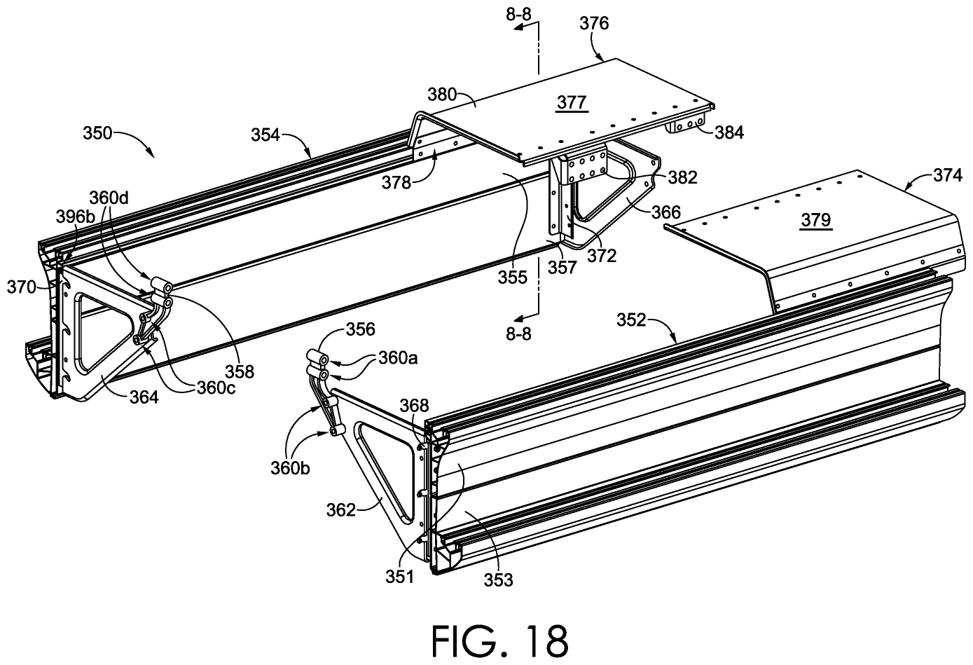

Looking now at FIG. 18, another configuration of a side-impact protection system 350 is shown, in accordance with embodiments of the present disclosure. The side-impact protection system 350 includes a pair of side-impact protection devices 352, 354. The side-impact protection devices 352, 354 are configured to be mounted on, over, and/or against lateral sides of one or more components, systems, and/or assemblies that are supported at least partially under a chassis of a vehicle (e.g., as shown in FIGS. 1 and 2 herein). In embodiments, the side-impact protection devices 352, 354 shown in FIG. 18 can be mounted on opposite sides of a battery system that is supported at least partially under a pair of chassis frame rails forming part of a battery electric vehicle.

In some embodiments, the side-impact protection devices 352, 354 can be attached directly to the lateral sides of a structure supported at least partially under a chassis. In some embodiments, the side-impact protection devices 352, 354 can be attached directly to a chassis, e.g., the chassis 14 shown in FIGS. 1 and 2, of a vehicle. In some embodiments, the side-impact protection devices 352, 354 can be attached to both the lateral sides of a supported structure and to a chassis, e.g., to leverage more points of securement and provide even greater stability.

The side-impact protection devices 352, 354 can each be formed from multiple pieces that are assembled together. For example, as shown in FIG. 18, the side-impact protection devices 352, 354 are each formed from at least two distinctly formed pieces 351, 353 and 355, 357 that are assembled together. In embodiments, these pieces or others can be formed using any of the manufacturing processes described herein, e.g., extrusion, casting, bending, stamping, or the like. In embodiments, these pieces or others can be attached together using any of the attachment methods described herein (e.g., interlocking structures, fasteners, welding, or the like).

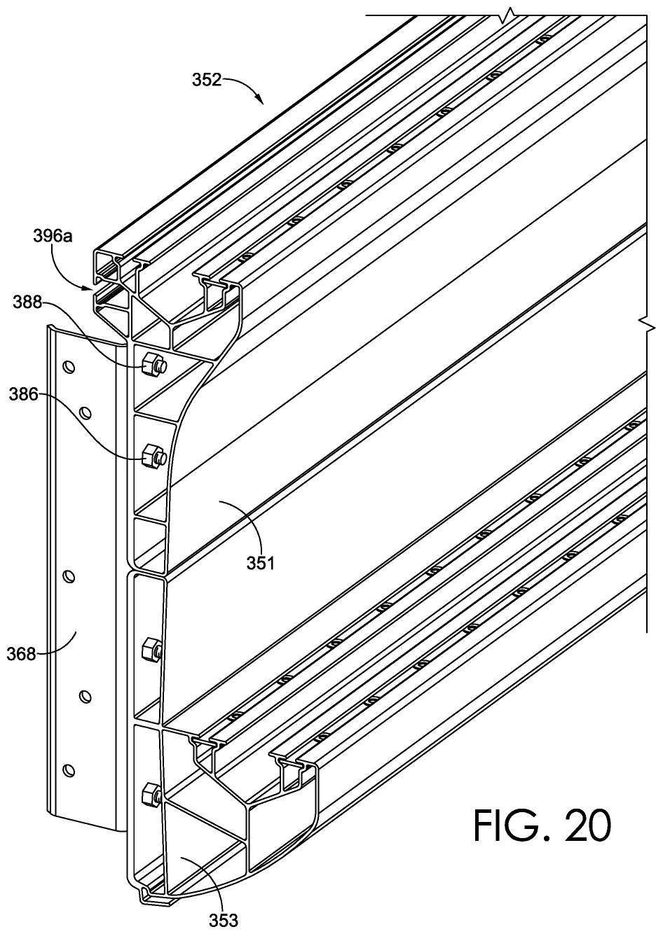

The side-impact protection devices 352, 354 can be attached to a chassis, e.g., to a pair of frame rails thereof. To allow for this attachment, the side-impact protection system 350 includes a series of brackets. This includes brackets 356, 358 that are each configured to attach a corresponding end of one of the side-impact protection devices 352, 354 to a chassis. The brackets 356, 358 can be cast, e.g., to form stand-off or displacement brackets as shown in the example of FIG. 18. The brackets 356, 358 each include corresponding apertures 360a, 360d through which fasteners can be extended to attach the corresponding brackets 356, 358 to a chassis. The brackets 356, 358 also each include corresponding apertures 360b, 360c through which fasteners can be extended to thereby attach the brackets 356, 358 to corresponding support brackets 362, 364. In the depicted embodiment, the support brackets 362, 364 are three-sided brackets that are attached to corresponding support brackets 368, 370 (e.g., using fasteners). The support brackets 368, 370 are configured to be attached to the pieces 351, 353 or 355, 357 of the corresponding side-impact protection devices 352, 354. FIG. 20 shows more detail of the bracket 368. The bracket 370 can have a similar configuration. The brackets 368, 370 help secure the pieces 351, 353 and 355, 357 in fixed relation as shown in FIGS. 18-20. FIG. 18 primarily depicts bracket assemblies at one end of the side-impact protection system 350. However, a similar configuration of brackets and attachments can be provided at the opposite end of the side-impact protection system 350 to secure the pieces 351, 353 and 355, 357 together, e.g., like brackets 366, 372.

FIG. 18 also shows additional components of the side-impact protection devices 352, 354 in the form of bracket assemblies 374, 376 that provide deck-plate coverings 377, 379. The bracket assembles 374, 376 allow the side-impact protection devices 352, 354 to be attached to the chassis while also allowing the deck-plate coverings 377, 379 to extend at least partially over certain vehicle structures, e.g., fuel tanks, gas tanks, batteries, or the like, and provide a supported surface. The bracket assembly 376 includes a bracket 378 that is attached to the piece 355. The bracket 378 is also attached to a larger panel-type bracket 380 which is attached to a pair of brackets 382, 384 that can be attached to the chassis and thereby secure the bracket assembly 376 to the chassis. In embodiments, this connection may be in addition to securement provided by the brackets 366, 372. The brackets can be secured to adjacent structures using any of the attachment methods described herein (e.g., fasteners, welding, or the like). The bracket assembly 374 can have a similar configuration as the bracket assembly 376. In other words, in embodiments, the bracket assemblies 374, 376 can have generally mirrored configurations.

Looking now at FIG. 20, an enhanced depiction showing how the bracket 368 is attached to the pieces 351, 353 of the side-impact protection device 352 and thereby helps secure the pieces 351, 353 in fixed relation is provided, in accordance with embodiments of the present disclosure. In the depicted embodiment, fasteners, e.g., 386, 388, are inserted through corresponding apertures in the bracket 368 and pieces 351, 353 to thereby secure the bracket 368 against the pieces 351, 353. In embodiments, additionally or alternatively, the pieces 351, 353 can be connected with integrally formed attachment structures, e.g., male-female or snap-fit features, as described herein.

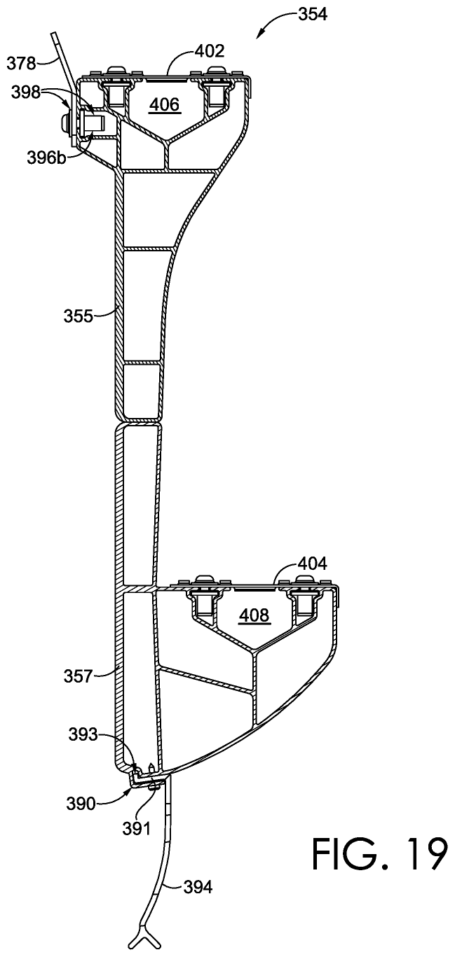

Looking now at FIG. 19, a cross-section of the side-impact protection device 354 of FIG. 18, looking along cut-line 8-8 as identified in FIG. 18, is shown, in accordance with embodiments of the present disclosure. FIG. 19 shows the pieces 355, 357 that are assembled together to form the overall shape of the side-impact protection device 354. FIG. 19 also shows the bracket 378 that is attached to the piece 355 allowing it to be attached to the larger panel-type bracket 380 shown in FIG. 18. FIG. 19 also shows a mini-fairing 394 attached to the piece 357 via an attachment 390. The attachment 390 can be similar to the attachment 200 shown in FIG. 8, e.g., leveraging the engagement of integrally formed structures for simpler assembly and disassembly. The attachment 390 allows the mini-fairing 394 to be reversibly coupled to the piece 357 and help define part of an external profile. In some embodiments, the attachment of the mini-fairing 394 can be provided via fasteners (e.g., self-tapping screws, or the like). In some embodiments, the attachment of the mini-fairing 394 can be provided without fasteners, clamps, or clips, and instead can be provided using a friction or interference fit. Looking at the embodiment depicted in FIG. 19, the mini-fairing 394 includes an extension 391, and the piece 357 includes a channel 393, and thus the attachment 390 is formed through insertion of the extension 391 into the channel 393 as shown in FIG. 19.

Looking at FIG. 19, it can be seen that the piece 355 has an elongated channel or slot 396b formed therein. The elongated channel or slot 396b can be formed as an integral part of the piece 355, e.g., during a manufacturing process such as extrusion. FIG. 20 depicts a similar elongated channel or slot 396a formed in the piece 351. FIG. 19 shows how the channel or slot 396b allows the bracket 378 to be attached to the piece 355 with a nut-plate 398 that is inserted into the channel or slot 396b and secured. The channels or slots 396a, 396b can be used similarly for attaching other structures, and allow for easier insertion and removal of a nut-plate due to the open ends of the channels 396a, 396b as shown, for example, in FIG. 20. The inclusion of the elongated channels or slots 396a, 396b can reduce the need for machining holes in the pieces 351, 353 or 355, 357 to accommodate fasteners, and thus can help reduce manufacturing complexity. In addition, the use of integrally formed channels/slots and nut-plates can allow for attachment of structures at different locations along the pieces, e.g., 351, 353 or 355, 357, enabling greater adaptability. It can be seen in FIG. 19 that this configuration is incorporated elsewhere on the pieces 355, 357 as well, e.g., in connection with step-plates 402, 404. FIGS. 19 and 20 show how the step-plates 402, 404 are secured to the corresponding pieces 355, 357 over corresponding gutters 406, 408 using a similar configuration as that provided for the bracket 378, e.g., elongated channel/slot and nut-plate engagement. The gutters 406, 408 can be integrally formed in the pieces 355, 357, e.g., during a manufacturing process such as extrusion, and can allow for drainage through the pieces 355, 357.

In embodiments, a side-impact protection device may be an elongated piece formed through extrusion (e.g., metal or polymer extrusion). Any or all of the pieces may have a slot, groove, or channel formed therein along at least part of a longitudinal length of the piece, which allows a nut, bolt, and/or plate attachment or other fastening configuration to be used to attach the piece against a vehicle structure with limited need for fastener-specific holes to be machined. This allows for easier assembly, disassembly, and simpler manufacturing and replacement.

In embodiments, a side-impact protection device is configured to provide lateral impact protection while having a compact configuration that allows it to fit into a lateral area adjacent to a component being protected. The device can be formed from multiple pieces that assemble together to form the side-impact protection device to facilitate manufacturing efficiency. The device can include a first layer of components that are inner-facing and that can be attached to a lateral side or surface of a component that is to be protected, e.g., battery system, fuel source, powertrain component, or the like. The first layer of components can be one or more brackets of various shapes, sizes, thicknesses, materials, and tensile strengths. The first layer of components can be attached directly to the lateral side or surface, or indirectly, e.g., via an interposed support structure or frame. The device can include a second layer of components, e.g., configured to be collapsible, compressible, and/or deformable of a desired degree or amount when subjected to impact forces to thereby provide a desired degree of impact absorption. The second layer of components can include one or more panels, as described herein, and/or one or more compartmented structures, e.g., as described herein. The device can optionally include a third layer of components, e.g., that form part of an exterior profile. The third layer can be a fairing, cover, shroud, or step assembly, among other things.

In embodiments, a method of manufacturing a side-impact protection device according to any of the embodiments described herein is provided.

In embodiments, a method of installing and/or integrating a side-impact protection device according to any of the embodiments described herein is provided.

In embodiments, a method of operating a vehicle or directing operation of multiple vehicles that include any of the side-impact protection devices described herein is provided.

The embodiments disclosed herein can be implemented with cars, trucks, freight carriers including freight tractors, machinery, equipment, and/or other types of mobile platforms. In addition, the embodiments herein can be used with electric-powered vehicles or platforms and with combustion-powered vehicles or platforms, and with hybrid-combustion-electric powered vehicles or platforms. For example, the subject matter of this disclosure can be used with internal combustion engine (“ICE”) vehicles; electric vehicles (“EV”); battery electric vehicles (“BEV”); hybrid electric vehicles (“HEV”); plug-in electric vehicles (“PHEV”); and with fuel-cell electric vehicles (“FCEV”), among others.

Clause 1. A side-impact protection device for a battery system supported under a chassis of a vehicle, the device comprising: a plurality of pieces configured to be assembled together to form an impact-absorbing structure shaped to at least partially enclose a lateral side of the battery system and form: an outer-facing side that supports a fairing, and an inner-facing side that attaches to at least the lateral side of the battery system.

Clause 2. The side-impact protection device of clause 1, wherein the plurality of pieces include: a plurality of brackets configured to be attached to the lateral side of the battery system; and a panel configured to be attached to the plurality of brackets such that the panel extends between the plurality of brackets, and can be maintained in spaced-relation with the lateral side of the battery system.

Clause 3. The side-impact protection device of clause 1 or 2, wherein the plurality of pieces include: a plurality of brackets configured to be attached to the lateral side of the battery system; and a compartmented structure configured to be attached to the plurality of brackets such that the compartmented structure extends between the plurality of brackets, and can be maintained in spaced-relation with the lateral side of the battery system.

Clause 4. The side-impact protection device of any of clauses 1-3, wherein the plurality of pieces include: a compartmented structure that comprises the inner-facing side and the outer-facing side and that is configured to be attached directly against the lateral side of the battery system, or a plurality of compartmented structures that together comprise the inner-facing side and the outer-facing side and that are configured to be attached directly against the lateral side of the battery system.

Clause 5. The side-impact protection device of any of clauses 1-4, wherein the plurality of pieces include: a first compartmented structure that forms a lower portion of the side-impact protection device upon assembly, and that comprises a first integrally-formed attachment structure; and a second compartmented structure that forms an upper portion of the side-impact protection device upon assembly, and that comprises a second integrally-formed attachment structure, wherein the first integrally-formed attachment structure and the second integrally-formed attachment structure are configured to be reversibly coupled to each other.

Clause 6. The side-impact protection device of any of clauses 1-5, wherein the first integrally-formed attachment structure and the second integrally-formed attachment structure comprise a male-female attachment.

Clause 7. The side-impact protection device of any of clauses 1-6, wherein the first integrally-formed attachment structure and the second integrally-formed attachment structure comprise an interlocking attachment.

Clause 8. The side-impact protection device of any of clauses 1-7, wherein the fairing is integrally formed with the outer-facing side.

Clause 9. The side-impact protection device of any of clauses 1-8, wherein the fairing is distinctly formed and attached to the outer-facing side.

Clause 10. The side-impact protection device of any of clauses 1-9, wherein the impact-absorbing structure comprises at least one panel that is configured to be supported in spaced-relation with the lateral side of the battery system.

Clause 11. The side-impact protection device of any of clauses 1-10, wherein the panel comprises a corrugated panel.

Clause 12. The side-impact protection device of any of clauses 1-11, wherein the panel comprises a plurality of sheets of material coupled together.

Clause 13. A vehicle with an electric powertrain, the vehicle comprising: a chassis; a battery system attached to, and supported at least partially under, the chassis, the battery system comprising a first lateral side and a second lateral side opposite to the first lateral side; and a side-impact protection system, comprising: a first side-impact protection device that includes a first impact-absorbing structure shaped to at least partially enclose the first lateral side of the battery system, and a second side-impact protection device that includes a second impact-absorbing structure shaped to at least partially enclose the second lateral side of the battery system, the first and second side-impact protection devices each comprising: an outer-facing side that supports a corresponding fairing, and an inner-facing side that attaches to the corresponding first lateral side or second lateral side of the battery system.

Clause 14. The vehicle of clause 13, wherein the first and second side-impact protection devices are each attached directly to the corresponding first lateral side or second lateral side of the battery system without being attached directly to the chassis.

Clause 15. The vehicle of clause 13 or 14, wherein each fairing is integrally formed with the corresponding outer-facing side.

Clause 16. The vehicle of any of clauses 13-15, wherein each fairing is distinctly formed and attached to the corresponding outer-facing side.

Clause 17. The vehicle of any of clauses 13-16, wherein the first and second side-impact protection devices are each formed from a plurality of pieces that couple together with integrally-formed attachment structures.

Clause 18. A method of integrating a side-impact protection system into a vehicle that includes a chassis and a battery system supported at least partially under the chassis, the battery system comprising a first lateral side and a second lateral side, the method comprising: attaching a first side-impact protection device to the first lateral side of the battery system; attaching a first fairing to the first side-impact protection device such that the first fairing at least partially encloses the first side-impact protection device; attaching a second side-impact protection device to the second lateral side of the battery system; and attaching a second fairing to the second side-impact protection device such that the second fairing at least partially encloses the second side-impact protection device.

Clause 19. The method of clause 18, wherein the first and second side-impact protection devices are each attached directly to the corresponding first lateral side or second lateral side of the battery system without being attached directly to the chassis.

Clause 20. The method of clause 18 or 19, further comprising forming each side-impact protection device by: extruding a plurality of metal pieces; and connecting the plurality of extruded metal pieces together by coupling together integrally formed attachment structures formed on the plurality of extruded metal pieces.

Clause 21. The method of any of clauses 18-20, wherein attaching the first and second side-impact protection devices to the corresponding first and second lateral sides of the battery system comprises: attaching a plurality of brackets to the corresponding first or second lateral side of the battery system; and attaching a panel to the plurality of brackets such that the panel is maintained in spaced relation with the battery system.

Clause 22. The method of any of clauses 18-21, wherein attaching the first and second side-impact protection devices to the corresponding first and second lateral sides of the battery system comprises: attaching a plurality of brackets to the corresponding first or second lateral side of the battery system; and attaching a compartmented structure to the plurality of brackets such that the compartmented structure is maintained in spaced relation with the battery system.

In some embodiments, this disclosure may include the language, for example, “at least one of [element A] and [element B].” This language may refer to one or more of the elements. For example, “at least one of A and B” may refer to “A,” “B,” or “A and B.” In other words, “at least one of A and B” may refer to “at least one of A and at least one of B,” or “at least either of A or B.” In some embodiments, this disclosure may include the language, for example, “[element A], [element B], and/or [element C].” This language may refer to either of the elements or any combination thereof. In other words, “A, B, and/or C” may refer to “A,” “B,” “C,” “A and B,” “A and C,” “B and C,” or “A, B, and C.” In addition, this disclosure may use the term “and/or” which may refer to any one or combination of the associated elements.

The subject matter of this disclosure has been described in relation to particular embodiments, which are intended in all respects to be illustrative rather than restrictive. In this sense, alternative embodiments will become apparent to those of ordinary skill in the art to which the present subject matter pertains without departing from the scope hereof. In addition, different combinations and sub-combinations of elements disclosed, as well as use and inclusion of elements not shown, are possible and contemplated as well.

What is claimed is:

1. A side-impact protection device for a battery system supported under a chassis of a vehicle, the device comprising:
a plurality of pieces configured to be assembled together to form an impact-absorbing structure shaped to at least partially enclose a lateral side of the battery system and form:
an outer-facing side that supports a fairing, and
an inner-facing side that attaches to at least the lateral side of the battery system.

2. The side-impact protection device of claim 1, wherein the plurality of pieces include:
a plurality of brackets configured to be attached to the lateral side of the battery system; and
a panel configured to be attached to the plurality of brackets such that the panel extends between the plurality of brackets, and can be maintained in spaced-relation with the lateral side of the battery system.

3. The side-impact protection device of claim 1, wherein the plurality of pieces include:
a plurality of brackets configured to be attached to the lateral side of the battery system; and
a compartmented structure configured to be attached to the plurality of brackets such that the compartmented structure extends between the plurality of brackets, and can be maintained in spaced-relation with the lateral side of the battery system.

4. The side-impact protection device of claim 1, wherein the plurality of pieces include:
a compartmented structure that comprises the inner-facing side and the outer-facing side and that is configured to be attached directly against the lateral side of the battery system, or
a plurality of compartmented structures that together comprise the inner-facing side and the outer-facing side and that are configured to be attached directly against the lateral side of the battery system.

5. The side-impact protection device of claim 1, wherein the plurality of pieces include:
a first compartmented structure that forms a lower portion of the side-impact protection device upon assembly, and that comprises a first integrally-formed attachment structure; and
a second compartmented structure that forms an upper portion of the side-impact protection device upon assembly, and that comprises a second integrally-formed attachment structure, wherein the first integrally-formed attachment structure and the second integrally-formed attachment structure are configured to be reversibly coupled to each other.

6. The side-impact protection device of claim 5, wherein the first integrally-formed attachment structure and the second integrally-formed attachment structure comprise a male-female attachment.

7. The side-impact protection device of claim 5, wherein the first integrally-formed attachment structure and the second integrally-formed attachment structure comprise an interlocking attachment.

8. The side-impact protection device of claim 1, wherein the fairing is integrally formed with the outer-facing side.

9. The side-impact protection device of claim 1, wherein the fairing is distinctly formed and attached to the outer-facing side.

10. The side-impact protection device of claim 1, wherein the impact-absorbing structure comprises at least one panel that is configured to be supported in spaced-relation with the lateral side of the battery system.

11. The side-impact protection device of claim 10, wherein the panel comprises a corrugated panel.

12. The side-impact protection device of claim 10, wherein the panel comprises a plurality of sheets of material coupled together.

13. A vehicle with an electric powertrain, the vehicle comprising:
a chassis;
a battery system attached to, and supported at least partially under, the chassis, the battery system comprising a first lateral side and a second lateral side opposite to the first lateral side; and
a side-impact protection system, comprising:
a first side-impact protection device that includes a first impact-absorbing structure shaped to at least partially enclose the first lateral side of the battery system, and
a second side-impact protection device that includes a second impact-absorbing structure shaped to at least partially enclose the second lateral side of the battery system,
the first and second side-impact protection devices each comprising:
an outer-facing side that supports a corresponding fairing, and
an inner-facing side that attaches to the corresponding first lateral side or second lateral side of the battery system.

14. The vehicle of claim 13, wherein the first and second side-impact protection devices are each attached directly to the corresponding first lateral side or second lateral side of the battery system without being attached directly to the chassis.

15. The vehicle of claim 13, wherein each fairing is integrally formed with the corresponding outer-facing side.

16. The vehicle of claim 13, wherein each fairing is distinctly formed and attached to the corresponding outer-facing side.

17. The vehicle of claim 13, wherein the first and second side-impact protection devices are each formed from a plurality of pieces that couple together with integrally-formed attachment structures.

18. A method of integrating a side-impact protection system into a vehicle that includes a chassis and a battery system supported at least partially under the chassis, the battery system comprising a first lateral side and a second lateral side, the method comprising:
attaching a first side-impact protection device to the first lateral side of the battery system;
attaching a first fairing to the first side-impact protection device such that the first fairing at least partially encloses the first side-impact protection device;
attaching a second side-impact protection device to the second lateral side of the battery system; and
attaching a second fairing to the second side-impact protection device such that the second fairing at least partially encloses the second side-impact protection device.

19. The method of claim 18, wherein the first and second side-impact protection devices are each attached directly to the corresponding first lateral side or second lateral side of the battery system without being attached directly to the chassis.

20. The method of claim 18, further comprising forming each side-impact protection device by:
extruding a plurality of metal pieces; and
connecting the plurality of extruded metal pieces together by coupling together integrally formed attachment structures formed on the plurality of extruded metal pieces.

21. The method of claim 18, wherein attaching the first and second side-impact protection devices to the corresponding first and second lateral sides of the battery system comprises:
attaching a plurality of brackets to the corresponding first or second lateral side of the battery system; and
attaching a panel to the plurality of brackets such that the panel is maintained in spaced relation with the battery system.

22. The method of claim 18, wherein attaching the first and second side-impact protection devices to the corresponding first and second lateral sides of the battery system comprises:
attaching a plurality of brackets to the corresponding first or second lateral side of the battery system; and
attaching a compartmented structure to the plurality of brackets such that the compartmented structure is maintained in spaced relation with the battery system.
